(19) United States
(12) Patent Application Publication
(10) Pub. No.: US 2026/0309547 A1
(43) Pub. Date: Oct. 8, 2026

(54) PULSE WINDOWING OPTICAL SENSOR

(71) Applicant: Tokyo Electron Limited, Tokyo (JP)

(72) Inventors: Ivan Maleev, Fremont, CA (US); Barton Lane, Austin, TX (US); Merritt Funk, Austin, TX (US); Jun Shinagawa, Fremont, CA (US)

(21) Appl. No.: 19/172,450

(22) Filed: Apr. 7, 2025

(51) Int. Cl. G01J 3/443; G01J 3/28

(52) U.S. Cl. CPC G01J 3/443; G01J 3/2803; G01J 2003/282; H01J 2237/334; H04N 25/71; H04N 25/713

(57) ABSTRACT

An optical emission spectroscopy detection device includes an optical collector configured to receive an optical signal, a photosensitive charge transfer array including sensor columns configured to shift charge between columns, and an optically dispersive element configured to generate a dispersed optical signal from the optical signal. The sensor columns includes an active column and at least one storage column. The active column is configured to accumulate photoelectrons during sampling intervals. The at least one storage column is configured to store column charge corresponding to respective sampling intervals. The dispersed optical signal is incident on and localized to the active column.

### TECHNICAL FIELD

The present invention relates generally to optical detection systems and methods, and, in particular embodiments, to systems and methods for optical detection of periodic optical sources.

### BACKGROUND

Optical detection techniques, such as optical emission spectroscopy (OES), are used to obtain information about material properties including elemental composition. During OES measurements, an optical sample is collected, dispersed, and detected to produce an optical spectrum. OES and other optical detection techniques have been used for in situ characterization and metrology of plasma systems, such as for plasma etching and plasma deposition processes. Conventional plasma OES is performed by coupling light from a plasma vacuum chamber to a spectrometer via a transmissive view port and/or fiber coupling system. Thereafter, spectral analysis is performed on the optical signal, whose feature extraction provides information about plasma species. The feature extraction of the spectral analysis over time can be used to obviate a process endpoint, known as process endpoint detection.

Pulsed plasma etching and deposition processes are gaining acceptance and applications in the semiconductor industry. Accurate characterization and metrology of plasma pulses (i.e., periodic response of a plasma to application of pulsed power, pulsed gas, measurement generated periodic events, or external generated events) can be used to control desired plasma parameters during the etch and the deposition processes, as well as to provide information for process endpoint detection. Some properties that may be monitored with sufficiently accurate measurements include kinetic reaction rates and process-specific atomic lines.

Useful spectral information may exist across the entire pulse development timeline of a plasma pulse for a given process. For example, it may be desirable to acquire OES measurements for initial ignition of plasma, the tail end of the pulse cycle (e.g., the afterglow), and other regions. Conventional OES techniques applied to pulsed plasma systems (or any system with a periodic optical source) are incapable of providing the desired combination of sensitivity (i.e., over the noise floor) and time resolution to accurately characterize all regions of a plasma pulse. For example, only a small amount of light is emitted by the plasma cloud over a given acquisition period for a spectral range of interest for many processes and plasma chamber configurations. In some cases, the number of photons per acquisition can be in the single digits or even less than unity, making measurements with existing noise-limited sensors impossible.

Therefore, improved optical detection systems and methods for optical characterization and metrology of pulsed optical sources, such as plasma pulses, may be desirable.

### SUMMARY

In accordance with an embodiment of the invention, an optical emission spectroscopy (OES) detection device includes an optical collector configured to receive an optical signal, a photosensitive charge transfer array including sensor columns configured to shift charge between columns, and an optically dispersive element configured to generate a dispersed optical signal from the optical signal. The sensor columns includes an active column and at least one storage column. The active column is configured to accumulate photoelectrons during sampling intervals. The at least one storage column is configured to store column charge corresponding respective sampling intervals. The dispersed optical signal is incident on and localized to the active column.

In accordance with another embodiment of the invention, a method of collecting optical data of a pulsed plasma using a photosensitive charge transfer array of sensor columns includes performing a sampling step and a reset step for each plasma pulse Pₘ of M>1 plasma pulses. The sensor columns include an active column and at least one storage column. The sampling step includes performing a collection step and a transfer step for each sampling interval Tₙ of N sampling intervals that a sampling interval T₁.

The collection step includes accumulating photoelectrons corresponding to the plasma pulse Pₘ into column charges Qₙ stored in the active column during the sampling interval Tₙ. The sampling interval Tₙ has a same predetermined temporal relationship ΔTₙ with each of the plasma pulses. The transfer step includes shifting stored charge in each of the sensor columns to respective adjacent columns to transfer the column charges Qₙ out of the active column.

The reset step includes, for m<M, shifting stored charge in each of the sensor columns to respective adjacent columns to transfer column charges Q₁ corresponding to the sampling interval T₁ to the active column. The method further includes reading out stored charge in each of the sensor columns as the optical data after accumulating photoelectrons corresponding to the last plasma pulse P_{M} during the last sampling interval T_{N}.

In accordance with still another embodiment of the invention, a OES system includes a pulsed plasma apparatus that includes a processing chamber and is configured to generate a plasma having M>1 plasma pulses in the processing chamber. The OES system also includes an OES detection device optically coupled to the plasma and including an optical collector configured to receive an optical signal, a photosensitive charge transfer array of sensor columns including an active column and at least one storage column, and an optically dispersive element configured to generate a dispersed optical signal from the optical signal. The dispersed optical signal is incident on and localized to the active column.

The OES system further includes a control and data acquisition circuit electrically coupled to the photosensitive charge transfer array and configured to perform a sampling step and a reset step for each plasma pulse Pₘ of the M>1 plasma pulses. The sampling step includes performing a collection step and a transfer step for each sampling interval Tₙ of N sampling intervals including a sampling interval T₁. The collection step includes accumulating photoelectrons corresponding to the plasma pulse Pₘ into column charges Qₙ in the active column during the sampling interval Tₙ. The sampling interval Tₙ has a same predetermined temporal relationship ΔTₙ with each of the plasma pulses. The transfer step includes shifting stored charge in each of the sensor columns to respective adjacent columns to transfer the column charges Qₙ out of the active column. The reset step includes, for m<M, shifting stored charge in each of the sensor columns to respective adjacent columns to transfer column charges Q₁ corresponding to the sampling interval T₁ to the active column. The control and data acquisition circuit is further configured to read out stored charge in each of the sensor columns as optical data after accumulating photoelectrons corresponding to the last plasma pulse P_{M} during the last sampling interval T_{N}.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A-1C illustrate example timing diagrams of a method of collecting optical data of a pulsed plasma where FIG. 1A shows three contiguous sampling intervals during each plasma pulse, FIG. 1B shows four contiguous sampling intervals at the tail of each plasma pulse, and FIG. 1C shows four sampling intervals spread out over various portions of each plasma pulse in accordance with embodiments of the invention;

FIG. 2 schematically illustrates an example photosensitive charge transfer array including sensor columns, each including X≥2 pixels, where the sensor columns have an active column and at least one storage column in accordance with embodiments of the invention;

FIG. 3 schematically illustrates an example OES detection device that includes an optically dispersive element implemented as a diffraction grating that is configured to generate a dispersed optical signal localized to an active column of a photosensitive charge transfer array in accordance with embodiments of the invention;

FIG. 4 schematically illustrates an example OES system that includes a pulsed plasma apparatus configured to generate a pulsed plasma in a processing chamber, an OES detection device optically coupled to the processing chamber, and a control system configured to cause the OES detection device to perform a method of collecting optical data of the pulsed plasma in accordance with embodiments of the invention;

FIG. 5 illustrates a flowchart of an example method of collecting optical data of a pulsed plasma that includes iterating a measurement phase for each of M>1 plasma pulses during which photoelectrons are accumulated in an active column of a photosensitive charge transfer array for one or more sampling intervals, with charges corresponding to a given sampling interval being transferred to storage columns when outside of the sampling interval and transferred back into the active column during the sampling interval, the stored charge in each of the sensor columns being read out as optical data after the final iteration of the measurement phase in accordance with embodiments of the invention;

FIGS. 6A-6C schematically illustrate an example method of collecting optical data of a pulsed plasma where photoelectrons corresponding to N=3 sampling intervals are accumulated during each of M≥3 plasma pulses, where FIG. 6A shows a first sampling step and reset step, FIG. 6B shows an m^{th} sampling step and reset step, and FIG. 6C shows the last (M^{th}) sampling step in accordance with embodiments of the invention;

FIG. 7 illustrates a flowchart of an example method of collecting optical data of a pulsed plasma where photoelectrons corresponding to a single sampling interval (N=1) are accumulated during each of M>1 plasma pulses in accordance with embodiments of the invention;

FIGS. 8A and 8B schematically illustrate a specific example of the method of FIG. 7 where FIG. 8A shows a first sampling step, blanking step, and reset step followed by an m^{th} sampling step, and where FIG. 8B shows an m^{th} blanking step and reset step followed by an M^{th} sampling step and a readout step in accordance with embodiments of the invention;

FIG. 9 illustrates a flowchart of an example method of collecting optical data of a pulsed plasma that omits the reset step in accordance with embodiments of the invention;

FIGS. 10A-10C schematically illustrate a specific example of the method of FIG. 9 wherein photoelectrons corresponding to N=3 sampling intervals are accumulated during M≥3 plasma pulses, where FIG. 10A shows collection and transfer steps for each sampling interval of a first plasma pulse followed by a collection and transfer step for the first sampling interval of an m^{th} plasma pulse, FIG. 10B shows collection and transfer steps for the remaining sampling intervals of the m^{th} plasma pulse followed by the first and second sampling intervals of an M^{th} plasma pulse, and FIG. 10C shows a collection step for the last sampling interval of the M^{th} plasma pulse followed by a readout step in accordance with embodiments of the invention;

FIG. 11 illustrates example broadband optical data collected using a 10 μs sampling interval; and

FIG. 12 illustrates example OES data collected using a 10μs sampling interval.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Conventional OES techniques are capable of monitoring emission spectra of periodic optical sources, such as pulsed plasma, when the number of photons is relatively high and when signals are averaged over time and over pulse duration. Over the duration of a given pulse (e.g., a plasma pulse resulting from the application of pulsed power to a gas in a plasma chamber), the spectrum (wavelengths and intensity) changes. Conventional OES techniques are unable to capture the evolution of the emission spectrum over the course of a pulse cycle because averaging and long acquisition times smooth out variations within the pulse cycle. As a result, while useful at a high level, conventional OES techniques fail to detect important fine structure of the emission spectra of the pulsed sources during a pulse cycle.

High-speed time-resolved OES techniques can provide measurements that resolve and provide information about the pulse shape in some circumstances, but only for a few wavelengths, or averaged over an undesirably broad range of wavelengths. Moreover, high-speed time-resolved OES techniques suffer even more from lack of photons since the acquisition must be fast. This may be especially apparent at the beginning and end portions of a pulse, and during the off time of each pulse cycle, when there may be a single detectable photon (or less) of a given wavelength per acquisition period. Notably, the end and off time of a pulse may be important regions of interest in many pulsed processes, such as pulsed plasma etching and depositions processes. Unfortunately, conventional high-speed time-resolved OES techniques are unable to acquire enough photons to accurately characterize the entire pulse cycle.

Therefore, improved optical detection systems and methods for optical characterization and metrology of pulsed optical sources, such as plasma pulses, may be desirable. In particular, improved optical detection systems and methods that can provide optical emission spectral information of a pulsed plasma over any desired region of the pulse development timeline, including initial ignition of plasma, the tail of the pulse, and off time at the end of a pulse cycle may be desirable.

In accordance with embodiments herein described, the invention provides systems, devices, and methods for collecting optical data of a periodic optical source (e.g., a pulsed plasma) that accumulates photoelectrons from desired sampling intervals over multiple pulses before reading out the optical data. The photoelectrons are accumulated in an active column of an array of photosensitive pixels. Specifically, photoelectrons corresponding to a given sampling interval are collected in the active column during the same part of each pulse. Collected photoelectrons that do not correspond to the current sampling interval are stored in storage columns of the photosensitive array. Before the current sampling interval, a photosensitive charge transfer array, such as a charge coupled device (CCD), may be used to transfer stored charge corresponding to collected photoelectrons of previous pulses to the active column to accumulate photoelectrons for the current sampling interval. Each pulse may also include one or more non-sampling intervals during which photoelectrons are not generated or not retained by the photosensitive array.

In various embodiments, a method of collecting optical data of a pulsed source, such as a pulsed plasma, uses a photosensitive charge transfer array of sensor columns comprising an active column and at least one storage column. The method includes performing a sampling step and a reset step for each pulse Pₘ of M>1 pulses (e.g., plasma pulses). The sampling step includes performing a collection step and a transfer step for each sampling interval Tₙ of N≥1 sampling intervals. That is, the sampling intervals include at least a sampling interval T₁ (which may or may not be the only sampling interval for each pulse).

The collection step includes accumulating photoelectrons corresponding to the pulse Pₘ into column charges Qₙ stored in the active column during the sampling interval Tₙ, wherein the sampling interval Tₙ has a same predetermined temporal relationship ΔTₙ with each of the pulse (e.g., a delay relative to an instant with a known relationship to the pulsed source, such as an applied source power pulse of a pulsed plasma). The transfer step includes shifting stored charge in each of the sensor columns to respective adjacent columns to transfer the column charges Qₙ out of the active column.

After each the sampling step is iterated for each of the N sampling intervals, the reset step is performed. The reset step includes shifting stored charge in each of the sensor columns to respective adjacent columns to transfer column charges Q₁ corresponding the sampling interval T₁ to the active column. For example, the purpose of the reset step is to prepare for the next pulse at which point photoelectrons will again be accumulated for the sampling interval T₁. In some cases, it may not be necessary to perform the reset step for the last pulse (i.e., P_{M}). In such cases, the reset step may only be performed when m<M.

After accumulating photoelectrons corresponding to the last plasma pulse P_{M} during the last sampling interval T_{N}. stored charge in each of the sensor columns is read out as the optical data.

Each of the sensor columns may include X>1 pixels that may be each store optical information. In various embodiments, each of the pixels in a sensor column is configured to store photoelectrons corresponding to different wavelengths (forming a spectrometer). Additionally or alternatively, pixels may also indicate other optical information, such as polarization information, coherence information, etc. Specifically, each pixel in the sensor columns may store intensity information as electric charge, while each row of the photosensitive array may indicate optical information (such as wavelength). Each column of the photosensitive array indicates a time period during the pulse (sampling interval), and may be moved within the array, such as using charge transfer techniques.

In various embodiments an optical detection device that may be used to perform the method of collecting optical data is an OES detection device that includes a photosensitive charge transfer array implemented as a CCD comprising sensor columns, which may be configured in a time delay integration (TDI) configuration. For example, the TDI configuration may allow column charges Qₙ (sets of electric charge that are stored in the individual pixels) to be moved from column to column in the CCD. In general, the OES detection device may be configured to shift charge between columns (e.g., rapidly), a TDI configuration being one specific implementation. The OES detection device may also include an optical collector configured to receive an optical signal and couple the optical signal to an optically dispersive element, such as a diffraction grating. The optically dispersive element is configured to generate a dispersed optical signal from the optical signal that is incident on and localized to the active column.

In various embodiments, an optical detection system that may be used to perform the method of collecting optical data is an OES system that includes a pulsed plasma processing apparatus, an OES detection device (such as described above), and a control and data acquisition circuit electrically coupled to a photosensitive charge transfer array of the OES detection device. The pulsed plasma apparatus includes a processing chamber and is configured to generate a plasma having M>1 plasma pulses in the processing chamber. The control and data acquisition circuit is configured to perform the method.

The invention may provide various advantages over conventional optical detection systems and methods. For example, conventional OES system are noise-limited in that they are unable to accumulate enough photons fast enough to overcome the noise floor, especially during lower intensity portions of a pulsed source, such as a pulsed plasma. The invention may advantageously overcome this practical limitation of existing sensor noise-limited systems. Specifically, the addition of photoelectrons from multiple pulses to accumulate a total collected signal may have the advantage of substantially exceeding sensor noise limits, including readout electronic noise.

Additionally, conventional OES systems and methods are limited to a few wavelengths or broad ranges of wavelengths (lacking spectral resolution). Another potential benefit of the invention is allowing multiple spectral wavelengths to be simultaneously collected during short-duration sampling intervals of interest for each pulse. The invention may be implemented as a spectrometer in various embodiments, advantageously enabling information about pulse shape at different wavelengths to be collected.

Another possible benefit of the invention is flexibility. Sensor columns may include any desired number of pixels to increase or decrease the resolution of the optical data (e.g., spectral resolution) to match a given application. The number of columns may be selected to accommodate the desired number of sampling intervals per pulse. The duration and location of the sampling intervals within a pulse may also be individually selected. Non-sampling intervals may be included to isolate regions of interest within the pulse and/or to exclude background noise. Alternatively, optical data (e.g., optical emission spectra) may be obtained analyzed continuously by choosing a set of sampling intervals that spans the entire pulse cycle.

In applications where the number of sampling intervals is limited (e.g., the number of columns is limited), different sets of sampling intervals may be processed separately. For example, optical data for a first set of sampling intervals (e.g., during the peak of the pulse) may be collected by accumulating photoelectrons for the first set of intervals during a number of pulses. The optical data may then be read out and optical data may then be collected for a second set of sampling intervals (e.g., focusing on the tail of the pulse and the off time of the pulse cycle). After another data readout step, the another set of sampling intervals may be processed, or the first set can again be processed again, and so on.

It should also be noted that the systems and methods of the invention are not limited to pulsed plasma optical emission analysis, but may be equally applicable to other cases where simultaneous spectral and time-resolved analysis of repeated pulses is desirable as may be understood by persons skilled in the art in view of this disclosure.

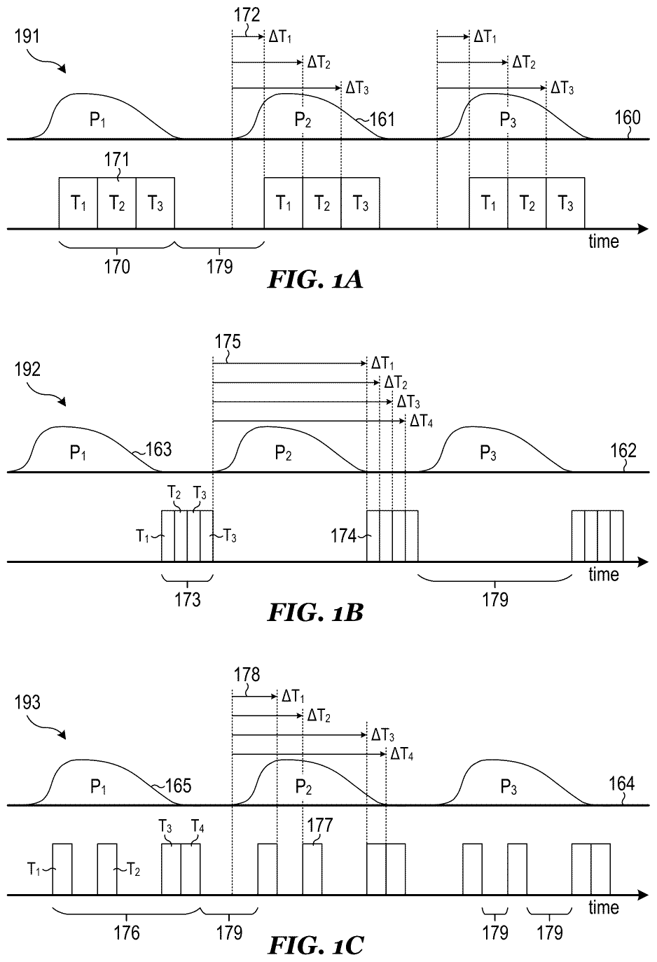

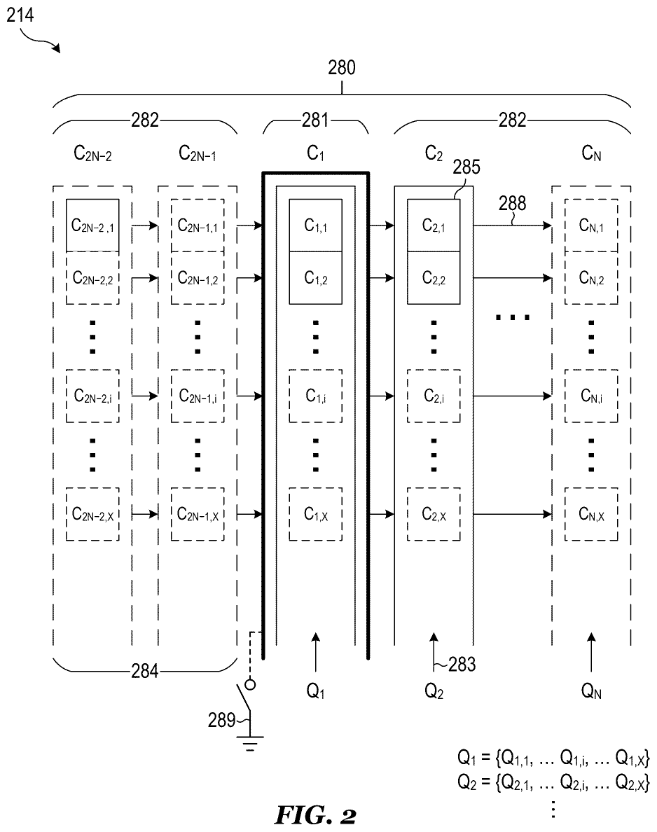

FIGS. 1A-1C illustrate example timing diagrams of a method of collecting optical data of a pulsed plasma where FIG. 1A shows three contiguous sampling intervals during each plasma pulse, FIG. 1B shows four contiguous sampling intervals at the tail of each plasma pulse, and FIG. 1C shows four sampling intervals spread out over various portions of each plasma pulse in accordance with embodiments of the invention.

Referring to FIG. 1A, an example timing diagram 191 for a method of collecting optical data of a periodic optical source is shown. For this example, the periodic optical source is referred to here as a pulsed plasma, but other periodic optical sources may also be analyzed. Specifically, the timing diagram 191 for the method of collecting optical data may be applicable for any optical event that creates a repeated change in optical properties of an optical source, such as repeated pulse events creating repeated changes in the optical properties of a plasma. The top graph shows pulse intensity (a.u.) versus time while the bottom graph shows sampling intervals versus time. The sampling intervals may be thought of as data collection windows that allow optical data to be processed only for desired portions of a pulse.

The timing diagram 191 shows a set of sampling intervals 170 (Tₙ) in predefined temporal relationships (ΔTₙ) with each plasma pulse 161 (Pₘ) of a sequence of plasma pulses 160, which is here shown as a time delay 172 between the start of each plasma pulse 161 (arbitrary reference point) and a respective sampling interval 171. That is, each of sampling interval 171 is synchronized with a desired region of the plasma pulse 161. Each time delay 172 may be programmed to be any desired value. The location and duration of each sampling interval 171 are selectable parameters, as long as the sampling intervals are non-overlapping, but each sampling interval 171 is the same between pulses during a given acquisition sequence.

The number of pulses in a sequence of pulses 160 may be one of the parameters that is controlled, such as in a data collection recipe. This number of pulses may directly relate to the amount of charge stored and may be considered a variable for controlling intensity (e.g., one of many possible variables for controlling intensity). The temporal relationship parameters ΔTₙ may be another example of variables that can be managed with the number of pulses being summed. For example, if ΔTₙ or the number of pulses is too large the cells with the maximum intensity may saturate. In some cases, this may not represent a problem (e.g., if the peak wave length is not important), but in other cases, it may be undesirable. One alternative may be to capture two different sequences, such as one with an increased number of pulses (e.g., to get high resolution of a large dynamic range). For instance, one sequence may pick up low emission spectral lines while another sequence controls the max intensity to avoid saturating pixels. This and other implementations may be part of an automatic control or recipe parameter.

In the specific example of the timing diagram 191, three sampling intervals (T₁, T₂, T₃) are contiguous and aligned with portions of the plasma pulse itself. A non-sampling interval 179 (e.g., where photoelectrons are not collected, i.e., not retained or not generated) separates the set of sampling intervals 170 of different pulses. However, any desired sampling interval configuration is possible, some additional examples of which are show in FIGS. 1B and 1C.

During the non-sampling interval 179 various techniques for avoiding the collection of photoelectrons may be employed. For example, photoelectrons may be generated, but not retained by discarding them (e.g., dumping the photoelectrons to ground, whether continuously, periodically, right before a subsequent sampling interval, etc.). In another technique that may be employed independently or in addition to discarding photoelectrons, some or all of the photons may be prevented from reaching the photosensitive array during the non-sampling interval 179, such as by physically blocking the incoming light.

Referring to FIG. 1B, a timing diagram 192 shows another set of sampling intervals 173 corresponding with each plasma pulse 163 of a sequence of plasma pulses 162. In contrast to the timing diagram 191, the example here demonstrates four contiguous sampling intervals (T₁, T₂, T₃, T₄) with shorter duration that are aligned with the off time of each plasma pulse 163. Each sampling interval 174 is offset from each plasma pulse 163 by a time delay 175. The set of sampling intervals 173 are again separated between pulses by a non-sampling interval 179.

Now referring to FIG. 1C, a timing diagram 193 shows still another set of sampling intervals 176 corresponding with each plasma pulse 165 of a sequence of plasma pulses 164. Each sampling interval 177 is again offset from each plasma pulse 164 by a time delay 178. Different from both the previous examples, the present example show noncontiguous sampling intervals (T₁, T₂, T₃, T₄) that are spread out to cover different regions of interest of each plasma pulse 165. Instead of only one non-sampling interval 179 per pulse cycle, the noncontiguous sampling intervals of the set of sampling intervals 176 are separated from one another by a respective non-sampling interval 179. The noncontiguous sampling configuration may capture a possible application where sampling rates are varied based on desired level of detail. For example, a higher sample rate may be used when a plasma is changing fast and more detailed sampling is desirable (e.g., higher sampling rate at the beginning of a pulse and a lower sampling rate in the afterglow).

The example timing diagrams of FIGS. 1A-1C are provided as a high level example of various sampling interval configurations, and innumerable other configurations are possible. For example, sampling intervals within the same set may also have different durations. In some embodiments, a single time delay may be triggered (e.g., by source power pulse), after which a clock signal is started and used to provide timing for the set of sampling intervals for a given pulse. For example, the first sampling interval may start on the first clock pulse and have a duration of three clock pulses, the second sampling interval may start on the eighth clock pulse and have a duration of five clock pulses, and so on. In other embodiments, the pulsed source and the sampling intervals may use the same clock (e.g., both may be controlled by a common controller). Of course, the clock frequency should be higher than the pulse frequency (e.g., substantially higher).

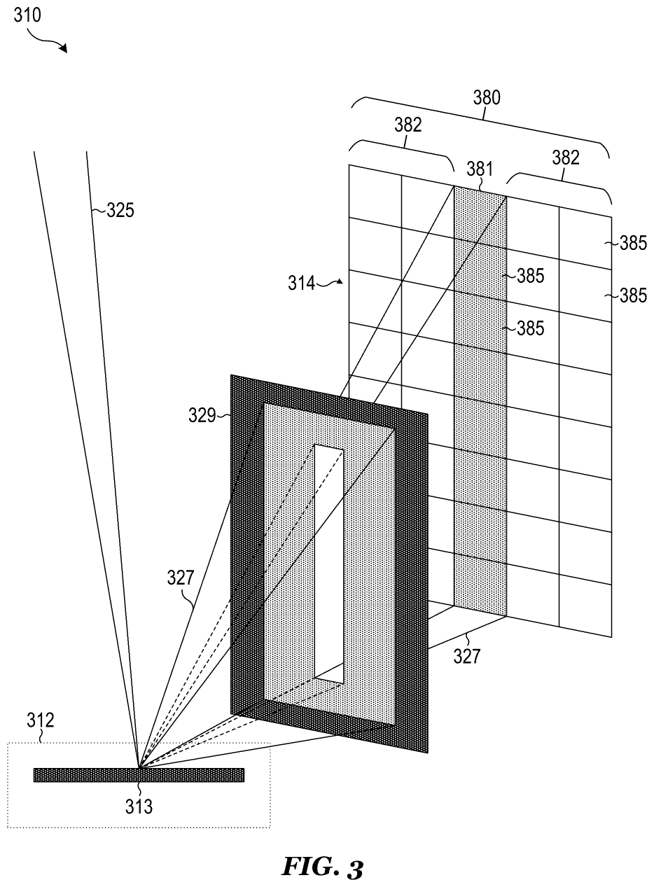

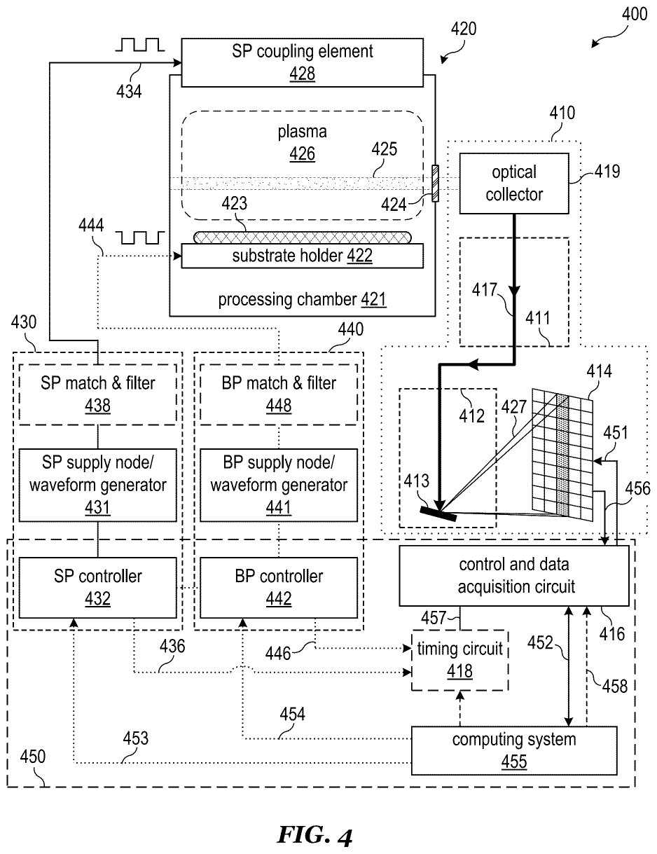

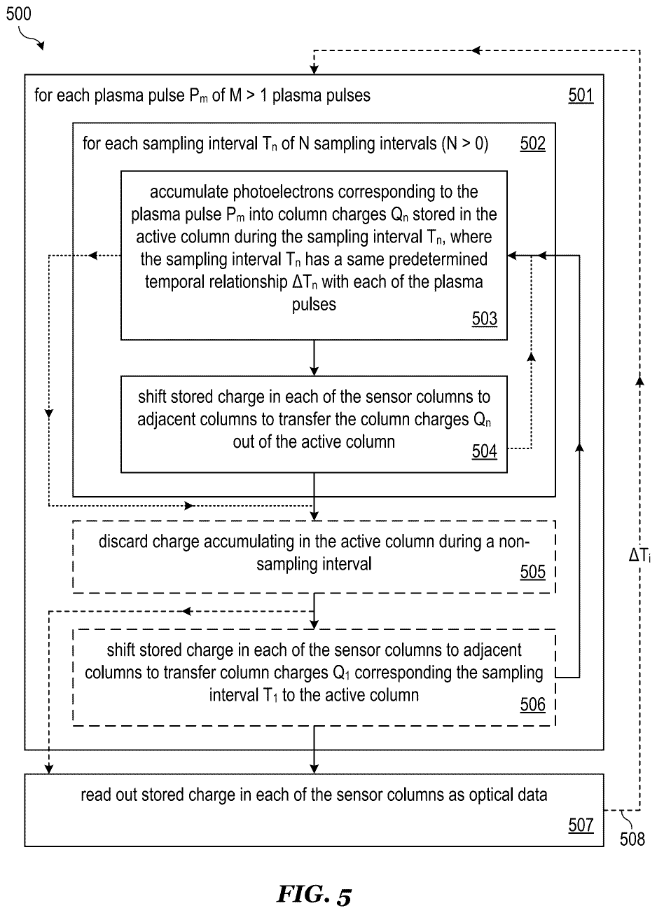

FIG. 2 schematically illustrates an example photosensitive charge transfer array including sensor columns, each including X≥2 pixels, where the sensor columns have an active column and at least one storage column in accordance with embodiments of the invention. The photosensitive charge transfer array of FIG. 2 may be used in devices and systems and to perform methods described herein such as the OES detection device of FIG. 3, the OES system of FIG. 4, and the method of FIG. 5, as examples. Similarly labeled elements may be as previously described.

Referring to FIG. 2, a photosensitive charge transfer array 214 is shown that includes sensor columns 280, each having X≥2 pixels 285 (at least two pixels and each column has the same number of pixels X). Each of the pixels 285 are configured to store electric charge accumulated from photoelectrons (Q_{n,i}). The stored charge in the pixels 285 of a single column may be referred to as column charges 283 (Qₙ={Q_{1,1}, . . . Q_{1,i}, . . . Q_{1,X}} ). The sensor columns 280 include an active column 281 (here shown as column C₁) and one or more storage columns 282. The active column 281 is configured to collect photoelectrons from an optical signal, such as a dispersed optical signal from a diffraction grating, for example. The storage columns 282 are configured to store column charges for which photoelectrons are not actively being accumulated (i.e., during non-sampling intervals and during sampling intervals not corresponding to the stored charge). Only the active column 281 is “active” so that it receives and converts incoming light into photoelectrons; the storage columns are masked and only used for storage and charge transfer.

There is no limitation on the number of pixels X (also referred to as the number of cells), although practical limitations may exist for a given application. The number of cells in combination with an optically dispersive element, such as a grating, may define the resolution (e.g., in nanometers). Consequently, in various embodiments, the number of cells is high, such as on the order of a thousand in some embodiments, and about 2000 in one embodiment.

For some applications a grating may be changed, such as to capture a fine resolution for a critical optical range that may relate to an end point signal. In one embodiment, the number of pixels is fixed for a system and control software, but the optically dispersive element (e.g., the grating) can be changed. This may have the advantage of providing control over scaling from pixel number to wavelength to suit a given application. A grating could be switched between processes and even process steps.

The pixels 285 of the sensor columns 280 are each electrically coupled to a respective pixel of an adjacent column through a charge transfer pathway 288. The column charges 283 can be made to move between the sensor columns 280 (e.g., by applying sequences of voltages to pixels, such as charged electrodes, to attract charges from one pixel to another). In particular, column charge Qₙ corresponding to sampling interval Tₙ can be transferred into the active column 281 during the sampling interval Tₙ and transferred out of the active column 281 and into one of the storage columns 282 during other included sampling intervals and non-sampling intervals.

In various embodiments, the photosensitive charge transfer array 214 is a CCD and the sensor columns 280 are in a TDI configuration in one embodiment. In other embodiments, a complementary metal-oxide-semiconductor type (CMOS-type) sensor with a photodiode and amplifier may be used to implement effective electronic shutter with gain switching option. In this method, gain switching functionality can be used to collect signal from the sampling windows of interest by itself or in combination with other approaches discussed in the disclosure. Specifically, in some embodiments, the photosensitive charge transfer array 214 is implemented using CMOS technology (e.g., an array of CMOS sensors). In one embodiment, the spectral data for each sampling interval is captured in an active column of the CMOS array and moved for storage during non-sampling intervals using gain switching. The CMOS array may be configured in a TDI configuration, for example.

For example, instead of using storage columns to transfer and store photoelectrons between pulses, some embodiments use a sensor with an electronic shutter with gain switching option. In that case the gain between intervals of interest in sequential pulses is switched off and no photoelectrons are collected. At the beginning of the next interval of interest the gain is switched on again and photoelectrons in the sensor active area continue to be collected (accumulate) and are added to the photoelectrons from previous pulses.

In alternative embodiments instead of segregating photoelectrons one may achieve similar desired effects by modulating incoming light instead. Specifically, the light from the desired sampling interval of multiple pulses may be collected, while the light from outside of the desired sampling window is suppressed one or more of the following techniques: (a) opto-electronic shutter with gain switching option; (b) mechanical optical switch such as an optical chopper; (c) microelectromechanical system (MEMS), deformable mirror, grating modulator, or other micro-mechanical motion device; (d) electro-optical modulator or switch (Pockels or Kerr effect based); (e) acousto-optical modulator switch (diffraction on acoustic wave effect); or (f) any other device that can periodically suppress incoming light outside of the desired sampling window interval of a pulse, and transfer the light to the detector during the desired sampling window interval of a pulse.

Various configurations may of the photosensitive charge transfer array 214 may be employed to suit the desired parameters of a given optical data collection application. In some embodiments, the photosensitive charge transfer array 214 is configured to accumulate photoelectrons corresponding to N>1 sampling intervals, such as N=3 sampling intervals. In one embodiment, the last storage column C_{N} is at an end of the photosensitive charge transfer array 214 (e.g., only has one adjacent sensor column connected via a charge transfer pathway 288). The column charges 283 may then be shifted forward after each sampling interval to make room in the active column for accumulated photoelectrons of the next sampling interval (e.g., transferred to the right, as shown, but of course the designation of “forward” is merely a label). For example, column charges Q₁ may be shifted forward until reaching the last storage column C_{N}.

The column charges Q₁ must then be shifted backward (e.g., left) until the column charges Q₁ are in the active column 281 again. For this reason, buffer columns 284 may be included so that the column charges to the left of the column charges (Q₁), which in the case of N=3 would be Q₂ and Q₃, have an available storage location. That is, in this example configuration, the sensor columns 280 include the active storage column C₁ and 2N−2 storage columns, with N−1 storage columns on each side of the active storage column (i.e., the number of sensor columns 280 is equal to twice the number of sampling intervals minus one).

In another embodiment where the photosensitive charge transfer array 214 is configured to accumulate photoelectrons corresponding to N>1 sampling intervals, the last column C_{N} may be electrically coupled to the active column 281 via a charge transfer pathway (not shown). That is, the sensor columns 280 may form a closed loop, whether physically such as with a flexible substrate or a double-sided substrate with charge transfer pathways from the frontside to the back side (e.g., with through-substrate vias), electrically with appropriate electrical connections connecting opposite ends of a planar array, or a combination thereof. In this example, when the column charges Q₁ reach the last column C_{N} they can be again shifted forward into the active column 281, which allows the buffer columns 284 to be omitted. Specifically, the sensor columns 280 may include an active column and N−1 storage columns in a close loop configuration.

In still another possible configuration, the photosensitive charge transfer array 214 may be configured to accumulate photoelectrons corresponding to only a single sampling interval for each pulse (N=1). In one embodiment, the sensor columns 280 include an active column and a single storage column. The column charges Q₁ accumulated during the sampling interval are then transferred into the single storage column during the non-sampling interval and transferred back to the active column for the subsequent sampling interval.

In some applications, such as when there is only a single sampling interval (N=1) during collection of optical data, a blanking mechanism may be included that allows the stored charge in the active column 281 to remain at zero. In one embodiment, a grounding element 289 may optionally be coupled to the active column 281 during non-sampling intervals to discard accumulated charge (e.g., dump charge to ground). In other embodiments, photoelectrons generated outside of the desired sampling intervals can be suppressed by using techniques that prevent photoelectrons from being accumulated in the active column 281 (e.g., in electronic wells of a CCD sensor). Some examples may include using a physical shutter, negatively biasing the active column 281, and others.

Continuing the above example where the sensor columns 280 includes only two sensor columns (an active column and a single storage column), the blanking mechanism may be utilized to ensure that the column charges Q₁ are transferred into an empty column after being stored for a non-sampling interval. Alternatively, a buffer column could be included when N=1 to allow the charge accumulated during the non-sampling interval to be transferred to the buffer column for storage. This may be thought of as a specific case of the above example where N=2 and the sensor columns 280 include an active column and 2N−2=2 storage columns where the second sampling interval is not of interest. However, this may be less desirable in situations where the active column may become saturated during non-sampling intervals.

Additionally, a blanking mechanism may be included in any configuration where it is desirable to avoid accumulating photoelectrons in the photosensitive charge transfer array 214 during non-sampling intervals. Some examples might include to avoid increasing the noise floor or to avoid saturating the detector when the regions of interest in a pulse have much fewer photons than the non-sampling intervals.

When the grounding element 289 is included as the blanking mechanism, an additional storage column may also be included (so that the total number of storage columns is at least N allowing charge in the active column to be discarded while the accumulated charge corresponding to each of the N sampling intervals is stored. This, in turn, may also allow optical data from noncontiguous sampling intervals to be collected. For example, after a first sampling interval is collected, the column charges Q₁ may be shifted forward while the remaining column charges remain in place. During a non-sampling interval following the first sampling interval, the charge accumulated in the active column may be discarded, and the column charges Q₂ corresponding to a second sampling interval may be shifted forward into the active column after the non-sampling interval. Of course, a similar technique may be used to insert non-sampling intervals at any desired point in the pulse cycle.

Alternatively or additionally, other methods (such as mechanical shuttering, optically guiding the incoming signal to other array columns, etc.) may be used to “move” the active column. Moreover, in some embodiments, more than one active column may be used, such as when spectral information is combined with other types of optical information, such as polarization, coherence, and others. The concept may also be further generalized to include multiple photosensitive charge transfer arrays, which may in some cases be used to expand the range of an optical detection device. Variations and specifics of these and other possible configurations may be apparent to those skilled in the art in view of the present disclosure.

FIG. 3 schematically illustrates an example OES detection device that includes an optically dispersive element implemented as a diffraction grating that is configured to generate a dispersed optical signal localized to an active column of a photosensitive charge transfer array in accordance with embodiments of the invention. The OES detection device of FIG. 3 may be used in systems and to perform methods described herein such as the OES system of FIG. 4 and the method of FIG. 5, as examples. Similarly labeled elements may be as previously described.

Referring to FIG. 3, an OES detection device 310, which is a specific example of optical detection devices described herein, includes a photosensitive charge transfer array 314. It should be noted that here and in the following a convention has been adopted for brevity and clarity wherein elements adhering to the pattern {x14} where ‘x’ is the figure number may be related implementations of a photosensitive charge transfer array in various embodiments. For example, the photosensitive charge transfer array 314 may be similar to the photosensitive charge transfer array 214 except as otherwise stated. An analogous convention has also been adopted for other elements as made clear by the use of similar terms in conjunction with the aforementioned numbering system.

The OES detection device 310 also includes an optically dispersive element 312, which is here shown as a diffraction grating 313, but of course other optically dispersive elements may be used. The optically dispersive element 312 is configured to receive and disperse an optical signal 325 to generate a dispersed optical signal 327. In particular, the optically dispersive element 312 may leverage various optical properties of the optically dispersive element 312 to spread out (i.e., disperse) the optical signal 325 according to some optical property, which is wavelength here. In various embodiments, the optically dispersive element 312 is a diffraction element, and is an adjustable diffraction element in one embodiment. Specifically, the adjustable diffraction element may be a variable diffraction element configured to be adjusted (e.g., manually or automatically, mechanically or electronically, such as to provide high resolution in a narrow spectral range).

The optically dispersive element 312 is further configured to provide the dispersed optical signal 327 to an active column 381 included in sensor columns 380 of the photosensitive charge transfer array 314. That is, the dispersed optical signal 327 is incident on the active column 381 and is also localized to the active column 381 (i.e., it does not contact storage columns 382 of the sensor columns 380, at least in such a way that photoelectrons are generated in the storage columns 382). The dispersed optical signal 327 may be produced in any suitable way, such as using a slit (as shown). Additionally, the dispersed optical signal 327 may be adjustable, such as to adjust resolution (e.g., the slit width may be variable, etc.).

The masking of the active column 381 to the exclusion of the storage columns 382 may be performed in any suitable way, including a physical mask, such as the optical mask 329 shown. It should be noted that the optical mask 329 is shown apart from the photosensitive charge transfer array 314 for illustrative purposes. The optical mask 329 may be a layer attached to the photosensitive charge transfer array 314 or may be separated from the photosensitive charge transfer array 314, as well a combination thereof.

In various embodiments, the optically dispersive element 312 and appropriate optical train separates incoming light into different wavelengths so that different pixels 385 within active column 381 register photons of different wavelengths allowing the collection of spectroscopic information about intensities at different wavelengths, forming a spectrometer. In some embodiments the pixels 385 may be configured to also store information about polarization, coherence, and other incoming light properties.

FIG. 4 schematically illustrates an example OES system that includes a pulsed plasma apparatus configured to generate a pulsed plasma in a processing chamber, an OES detection device optically coupled to the processing chamber, and a control system configured to cause the OES detection device to perform a method of collecting optical data of the pulsed plasma in accordance with embodiments of the invention. The OES system of FIG. 4 may be used to perform methods described herein such as the method of FIG. 5, for example. Similarly labeled elements may be as previously described.

Referring to FIG. 4, a pulsed plasma OES system 400 includes an OES detection device 410 optically coupled to a pulsed plasma processing apparatus 420 (e.g., using an optical window 424 such as a vacuum viewport, for example). The pulsed plasma OES system 400 is configured to be used to perform a plasma process (a pulsed plasma process in this case) using the pulsed plasma processing apparatus 420 during which OES measurements are collected. For example, the pulsed plasma processing apparatus 420 may include a substrate holder 422 (e.g., an electrostatic chuck, etc.) disposed in a processing chamber 421 and configured to support a substrate 423 (e.g., any suitable substrate such as a wafer) to be processed by a pulsed plasma 426.

The OES detection device 410 is optically coupled to the pulsed plasma 426 such that the OES detection device 410 receives an optical signal 425 from the pulsed plasma 426. An optical path 417 of the OES detection device 410 includes an optically dispersive element 412 and photosensitive charge transfer array 414. The optically dispersive element 412 may include a diffraction grating 413, as shown here. The optically dispersive element 412 is configured to generate a dispersed optical signal 427 from the optical signal 425 that is incident on and localized to an active column of the photosensitive charge transfer array 414.

The OES detection device 410 may also include an optical collector 419 that is optically coupled to the optically dispersive element 412 through optics 411 configured to direct the optical signal 425 to the optically dispersive element 412. That is, the optical collector 419 may be configured to be optically coupled to the pulsed plasma 426 and receive the optical signal 425 from the pulsed plasma 426. For example, the optical collector 419 and the optics 411 may include various components such as reflectors, lenses, apertures, splitters, fiber optics, and the like.

The photosensitive charge transfer array 414 may be implemented using various types of photodetectors capable of being configured to transfer charge between columns at speeds substantially faster than a pulse cycle of the pulsed plasma. In various embodiments, the photosensitive charge transfer array 414 is a CCD and has sensor columns configured in a TDI configuration in one embodiment.

The pulsed plasma OES system 400 includes a control and data acquisition circuit 416 (e.g., as part of the OES detection device 410 or as a separate element of the pulsed plasma OES system 400). The control and data acquisition circuit 416 is electrically coupled to the photosensitive charge transfer array 414. That is, the control and data acquisition circuit 416 is configured to transfer charge between columns and/or blank the active column using a column selection signal 451.

Additionally, the control and data acquisition circuit 416 is further configured to cause the photosensitive charge transfer array 414 to readout the stored charge in the sensor columns as optical data 456. That is, after light from the desired number of pulses is collected, photoelectrons may be transferred into the readout circuit, optionally amplified using appropriate electron multiplication circuit (EM-CCD), digitized using appropriate analog-to-digital-converter (ADC), and processed further as necessary. The optical data 456 may have a temporal resolution less than 100 μs, such as between about 100 μs and 100 ns, or even higher resolution. That is, the sampling intervals may have durations between about 2 μs and about 100 μs, for example.

Source power (SP) may be applied to an SP coupling element 428 of the pulsed plasma processing apparatus 420 using an SP control path 430 electrically coupled to the SP coupling element 428 to generate the pulsed plasma 426 in a processing chamber (e.g., contained by the processing chamber 421). Bias power (BP) may be applied to the substrate holder 422 using an optional BP control path 440. The bias power (e.g., a wafer bias) may create a potential difference between the substrate 423 and the pulsed plasma 426 that may be used to influence charged species of the pulsed plasma 426 during a plasma process (e.g., to accelerate ions/electrons towards or away from the substrate 423).

The SP control path 430 is configured to supply a sequence of SP pulses 434 to the SP coupling element 428 to generate the pulsed plasma 426. For example, the SP control path 430 may include an SP supply node/waveform generator 431 that is configured to supply source power (e.g., alternating current (AC) power such as radio frequency (RF) power) and modulate the source power to generate the sequence of SP pulses 434. An SP controller 432 may be configured to control the timing and parameters of the sequence of SP pulses 434. Sampling intervals used to obtain the optical data 456 may have the temporal resolution less than 100 μs so that desired portions of each pulse cycle can be characterized for the pulsed plasma 426. An optional SP match & filter 438 may be included between the SP supply node/waveform generator 431 and the SP coupling element 428 (e.g., for ensuring efficient coupling of the source power to the pulsed plasma 426).

Similarly, when included, the optional BP control path 440 may be configured to supply a sequence of BP pulses 444 to the substrate holder 422. For example, the optional BP control path 440 may include a BP supply node/waveform generator 441 that is configured to supply bias power (e.g., RF bias power, direct current (DC) bias power, or a combination thereof) and modulate the bias power to generate the sequence of BP pulses 444. A BP controller 442 may be configured to control the timing and parameters of the sequence of BP pulses 444. An optional BP match & filter 448 may be included between the BP supply node/waveform generator 441 and the substrate holder 422 (again, to ensuring efficient coupling of the bias power to the substrate 423, for example).

The pulsed plasma OES system 400 also includes a control system 450 operationally coupled to the OES detection device 410 and the SP control path 430 (and to the optional BP control path 440, when included). The control system 450 is configured to provide control of both the plasma process and the acquisition of optical data. For example, the control system 450 may include the control and data acquisition circuit 416, the SP controller 432, and the BP controller 442.

A timing circuit 418 may be included in the control system 450 (e.g., as part of or separate from the OES detection device 410). When included, the timing circuit 418 is electrically coupled to the control and data acquisition circuit 416 and is configured to control the timing for the collection of the optical data, such as by ensuring locked-in synchrony with the plasma pulses (e.g., timed according to the SP or BP). For example, the timing circuit 418 may include various components such a flip flop, a clock generator circuit, such as within a microcontroller, FPGA, and the like.

The timing circuit 418 may be configured to generate a setup delay in response to receiving a synchronization signal from the pulsed plasma processing apparatus 420. The control and data acquisition circuit 416 may be configured to use the synchronization signal (e.g., directly or indirectly from the timing circuit 418) to cause the OES detection device 410 to collect the optical data during selected portions of each pulse cycle of the pulsed plasma 426.

For example, the timing circuit 418 may be configured to receive a synchronization signal corresponding to the sequence of SP pulses 434 and use the synchronization signal to trigger the control and data acquisition circuit to perform iterations of a method of collecting optical data according to respective predetermined temporal relationships ΔTₙ with the SP pulses 434.

The synchronization signal may take a variety of forms. In one embodiment, the synchronization signal is an SP trigger signal 436 sent from the SP control path 430 (such as by the SP controller 432) and corresponds to the timing of the sequence of SP pulses 434. In some embodiments, the SP trigger signal 436 corresponds directly to the sequence of SP pulses 434 (such as rising and/or falling edges) and in other embodiments the SP trigger signal 436 is a separate signal sent a predetermined amount of time prior to the sequence of SP pulses 434. Similarly, the synchronization signal may also be (or include) a BP trigger signal 446 sent from the optional BP control path 440 (such as by the BP controller 442) and correspond to the timing of the sequence of BP pulses 444. The synchronization signal may also be (or include) an external signal or be triggered by another periodic event leading to repeated changes in the optical properties of the plasma, such as a gas pulsing trigger, for example.

The timing circuit 418 may be further configured to generate a clock signal and cause the OES detection device 410 to collect the optical data from the photosensitive charge transfer array 414 (e.g., by triggering the control and data acquisition circuit 416 to transfer stored charge in the sensor columns from the active column to storage columns after the setup delay according to the clock signal (such as at the clock signal frequency). In one embodiment, the timing circuit 418 is configured to use the synchronization signal to trigger the control and data acquisition circuit 416 by generating a sampling frequency greater than a pulse frequency of the sequence of SP pulses 434, generating a trigger signal having the sampling frequency after a setup delay triggered by the synchronization signal, and outputting a sampling trigger signal 457 to the control and data acquisition circuit 416. In various embodiments, the clock signal has a frequency greater than 10 kHz, and is about 100 kHz in one embodiment.

The control system 450 may also include a computing system 455 as part of the OES signal acquisition chain that is configured to send control signals to the control and data acquisition circuit 416, the SP controller 432, and the BP controller 442 (labeled as control and data signal 452, SP control signal 453, and BP control signal 454, respectively). The computing system 455 may include or function as an OES pulse control module in some embodiments. The control and data acquisition circuit 416 may be configured to process, amplify, and digitize the optical data for output to computing system 455 (e.g., in real-time or near real-time, such as for several pulses to hundreds of plasma pulses at a time). The computing system 455 may also be configured to log the optical data, define and extract features, and display the optical data. For example, the computing system 455 may include a graphical user interface allowing control and visualization of the OES data acquisition process.

In some embodiments, the computing system 455 may also provide the control and data acquisition circuit 416 with an optional external trigger 458, which may be used to trigger the control and data acquisition circuit 416 to perform iterations of a method of collecting optical data according to events not associated directly with the source power or bias power. Any event may trigger a sequence of OES measurements, even an external event supplied decided by a user. In one embodiment, the optional external trigger 458 is a process step software event. Each process step may be considered a pulse. For example, a repeated step or sequences of steps may result in a time varying plasma that may be considered a pulsed plasma. It may be desirable to measure the optical spectra in this situation to understand what is changing on the wafer surface or chamber environment.

Another example may be gas pulsing events. The trigger could be a gas pulse signal that is sent to a gas valve designed for fast pulsing. The optional external trigger 458 may be provided directly to the control and data acquisition circuit 416 or to the timing circuit 418 as the synchronization signal.

The computing system 455 may be any suitable type of computing system, including a digital computer, microprocessor, microcontroller, field-programmable gate array (FPGA), or application-specific integrated circuit (ASIC), with any suitable instruction set, such a complex instruction set computer (CISC), reduced instruction set computer (RISC), real-time operating system (RTOS) computer, etc. The computing system 455 may include a processor and a computer-readable non-transitory memory storing a program, that, when executed by the processor, causes the processor to perform the methods of collecting optical data of a pulsed source described herein. In some cases, the control and data acquisition circuit 416 may include a memory and processor configured to perform a portion of or all of the methods of collecting OES data of a plasma process.

Data acquisition may be triggered by the OES detection device 410 (such as by the control and data acquisition circuit 416) and a set of sampling intervals are recorded with predefined time widths and time delays (settable by the user) and accumulated across a desired number of plasma pulses before reading out and digitizing the optical data. The digitized signal may then be sent to the computing system 455 for further processing and monitoring.

Using program instructions (e.g., PC software methods, RTOS, RISC, etc.) features that are extracted may be time-trended to identify when the concentration of a given reacting species and/or byproduct has hit a limiting threshold value signifying completion of the plasma process (or a stage of the plasma process). An advantage may be that optical data for sampling intervals with time resolution significantly shorter than one pulse cycle may be assembled into spectrally resolved pulse shapes, yielding direct measurement of chemical reactions for process control. The control and data acquisition circuit 416 and computing system 455 may store measurement recipe settings that can be activated by process steps. For example, this can include the sample interval timing, the width of sample intervals, and spectral resolution changes (e.g., hardware changes), among others.

The pulsed plasma processing apparatus 420 may be any type of plasma processing apparatus configured to use the pulsed plasma 426 to process (e.g., modify, prepare, clean, etc.) the substrate 423. For example, the pulsed plasma processing apparatus 420 may be an etch tool, a deposition tool, a cleaning tool, plasma thinning or dicing tool, and the like. Additionally, the pulsed plasma processing apparatus 420 may be used for more than one type of plasma processing. The pulsed plasma 426 may be any type of plasma such as an inductively coupled plasma (ICP), capacitively coupled plasma (CCP), surface wave plasma (SWP), and others (where the implementation of the SP coupling element 428 may vary in order to generate plasma of a given type).

The optical signal 425 is illustrated as a light cylinder sampled from the pulsed plasma 426 to represent a possible region of the pulsed plasma 426 that is represented in the optical data. That is, initial light reaching the OES detection device 410 may in reality be more like a light cone, and the optical path 417 may include various components (such as in the optical collector 419) that filter and focus the light cone to create a pencil of light (i.e. a light cylinder) which is eventually sampled by the photosensitive charge transfer array 414.

One application of the pulsed plasma OES system 400 that may be particularly advantageous is endpoint detection (EPD) of the plasma process (e.g., a plasma process such as plasma etching or plasma deposition). EPD may be used to monitor the plasma process (in this case using the optical data) for an indication of an endpoint of the plasma process. The pulsed plasma processing apparatus 420 may then be instructed to terminate or change the plasma process in response to detecting the endpoint (e.g., by the computing system 455, the control and data acquisition circuit 416, or another controller). In some cases, the pulsed plasma OES system 400 may be advantageously used to obtain optical data during dim portions of the plasma pulses not otherwise measurable using conventional techniques, including initial ignition, the tail of a plasma pulse, and the afterglow.

Some examples of plasma processes for which EPD can be used are plasma-enhanced chemical vapor deposition (PE-CVD), atomic layer deposition (ALD), reactive ion etching (RIE), atomic layer etching (ALE). For example, EPD can be used to detect that the material being etched has been cleared to an underlying layer. Depending on the types of materials being etched and the etch process parameters, changes in the optical data of the pulsed plasma 426 at or near an endpoint of the etch process may be subtle and undetectable using conventional OES spectrometers (e.g., because the relevant processes occur at timescales shorter than a single pulse cycle). However, the OES detection device 410 may have the advantage of detecting many processes of interest for endpoint detection and process health, such as discharge phenomena, plasma recombination, and plasma chemistry including radical reactions, neutral species reactions, and species diffusion.

In a system with a conventional spectrometer the light is averaged over several pulses including the off periods in between pulses. The dark noise photoelectrons, which are produced by random thermal processes, accumulate in all pixels over the entire integration period including the off periods. For low duty cycle and dim pulsed plasmas these dark noise photoelectrons can degrade the signal, undesirably indicating a false endpoint. In contrast, the OES detection device 410 may have the advantage of providing accurate OES measurements, even in low duty cycle and dim pulsed plasma applications.

The detection advantages of the OES detection device 410 may be desirable in low exposed area situations. The change in the concentration of a radical species from the end of one pulse to the beginning of the next pulse may be an indication of the loss rate of the species due to volumetric and surface losses. The surface losses can depend on the state of the chamber walls which may play a big role in determining the reproducibility of a given process. The OES detection device 410 may beneficially detect changes in radical species at a sub-pulse temporal resolution providing an in situ diagnostic of the wall conditions. Since a decay time constant is being measured, this may be more robust measurement than measuring the magnitude of a set of spectral lines (which is conventionally the only alternative diagnostic).

It should be noted that a variety of implementation configurations exist for the control system 450. For example, some or all of the controllers of the various subsystems and devices of the pulsed plasma OES system 400 may be included in the respective subsystem or device. For example, as shown, the control and data acquisition circuit 416 may be included as part of the OES detection device 410, the SP controller 432 may be included as part of the SP control path 430, and so on. Further, various combinations of functionality of the controllers may be included in a single multifunctional controller of the control system 450, as a standalone controller, or in the computing system 455. Additionally, the control and data acquisition circuit 416 is shown as a single logical block for simplicity and may also be considered to include a separate controller circuit and a data and acquisition (DAQ) circuit.

The OES system 400 may also be used for optical measurements of what may be considered a continuous wave (CW) plasma as long as there are periodic optical events. For example, a plasma (CW or pulsed) may have repeated plasma events that may or may not be based on pulsed source power or pulsed bias power. The OES system 400 may be triggered based on a signal and a sampling recipe for some amount of periodic samples that are based on the repeated plasma event and for which information is desirable. In various embodiments, the repeated plasma event occurs with a repeated pattern so that the time between the capture event and the repeated pattern occurs more than once. The OES system 400 allows the summing up of measurements of the repeated plasma event (e.g., multiple a optical wavelength signals).

One application of the OES system 400 is measuring end point. The end point may vary depending on the plasma process. Some examples are the change in species in the plasma when one layer is opened up and another layer is exposed and when an etch byproduct changes in intensity for a combination of wavelengths. Using the OES system 400 with complex stacks the “pulse trigger” may be when a gas is changed, when an RF parameter is changed, or using the optical signal itself to detect a change in plasma properties and begin sampling for a number of artificially generated triggers of the OES system 400. This may then be used for analyzing anomalies in plasma or etch byproduct changes as features are etched.

FIG. 5 illustrates a flowchart of an example method of collecting optical data of a pulsed plasma that includes iterating a measurement phase for each of M>1 plasma pulses during which photoelectrons are accumulated in an active column of a photosensitive charge transfer array for one or more sampling intervals, with charges corresponding to a given sampling interval being transferred to storage columns when outside of the sampling interval and transferred back into the active column during the sampling interval, the stored charge in each of the sensor columns being read out as optical data after the final iteration of the measurement phase in accordance with embodiments of the invention.

The method of FIG. 5 may be combined with other methods and performed using the systems and apparatuses as described herein. For example, the method of FIG. 5 may be combined with aspects of any of the embodiments of FIGS. 1A-4 and 6A-10C. Although shown in a logical order, the arrangement and numbering of the steps of FIG. 5 are not intended to be limited. The method steps of FIG. 5 may be performed in any suitable order or concurrently with one another, and additional steps, including intervening steps, may be performed as may be apparent to a person of skill in the art.

Referring to FIG. 5, a method 500 of collecting optical data of a pulsed plasma using a photosensitive charge transfer array of sensor columns comprising an active column and at least one storage column includes a measurement phase 501 that is performed for each plasma pulse Pₘ of M>1 plasma pulses. The number of plasma pulses M may be any number greater than one. In various embodiments, the measurement phase 501 is performed for plasma pulses in the range of several pulses to hundreds of pulses. In one embodiment, the measurement phase 501 is performed for about one hundred plasma pulses (M=100). It should be noted that here and elsewhere in this disclosure, the term “plasma pulses” is used as one example of a broader concept that may be referred to as “plasma events”. The method 500 and other methods described herein are equally applicable to any periodic events, such as plasma events, one example of which are plasma pulses (and may refer to the actual behavior of the plasma itself, or to a pulsed parameter effecting the plasma, such as pulsed source power, bias power, gas, etc.).

The measurement phase 501 includes a sampling step 502 and a reset step 506. The sampling step 502 includes a collection step 503 and a transfer step 504 that are performed (i.e. alternated) for each sampling interval Tₙ of N sampling intervals. While the number of plasma pulses is at least two, any number of sampling intervals may be selected, including a single sampling interval. For example, the N sampling interval includes a sampling interval T₁ and may include additional sampling intervals in some embodiments.

For each iteration of the collection step 503, photoelectrons corresponding to the plasma pulse Pₘ are accumulated into column charges Qₙ stored in the active column during the sampling interval Tₙ. The (current) sampling interval Tₙ has a same predetermined temporal relationship ΔTₙ with each of the plasma pulses. During the transfer step 504, stored charge in each of the sensor columns is shifted to respective adjacent columns to transfer the column charges Qₙ out of the active column. For example, the column charges Qₙ may be transferred out of the active column to prepare for the next collection step 503 or to avoid accumulating photoelectrons during non-sampling intervals.

After all of the iterations of the sampling step 502 are performed for a given pulse Pₘ the reset step 506 is performed. Stored charge in each of the sensor columns is shifted during the reset step 506 to respective adjacent columns to reset the active column for the next pulse (i.e., to transfer column charges Q₁ corresponding to the sampling interval T₁ to the active column). After all of the iterations of the measurement phase 501 are performed, stored charge in each of the sensor columns is read out as optical data during a readout step 507. That is, once the photoelectrons from the selected sampling intervals of the desired number of pulses are stored in the sensor columns, they are read out and digitized to produce an output signal.

In some cases, it may not be necessary to shift the charge Q₁ back into the active column. In the system we actually used there was one active column. Photoelectrons may be produced continuously, but are discarded (e.g., bled off to ground) during non-sampling intervals in some embodiments. In this way, the photoelectrons may be accumulated during the sampling interval and added to an adjacent column at the end of the sampling interval to accumulate photoelectrons from each pulse.

If data for sampling intervals not included in the first set of sampling intervals is desired, the method 500 may be repeated for additional sampling intervals be performing additional measurement phases 508, reading out optical data after accumulating photoelectrons corresponding to the last sampling interval of the last plasma pulse.

The reset step 506 may be omitted for some or all of the iterations of the measurement phase 501. For example, the reset step 506 may not be needed for the last pulse P_{M} since the stored charge is being read out of the sensor columns. In some cases, reading out the stored charge may cause the stored column charges Q₁ to pass through the active column, which may be interpreted as the final reset step 506 or simply be considered part of the readout step 507. Additionally, in certain configurations that have been discussed and will be discussed in more detail in the following, the reset step 506 may not be needed when a charge transfer pathway is included between the last storage column and the active column (a closed loop configuration).

In various embodiments, a blanking step 505 may optionally be included during non-sampling intervals. During the blanking step 505, charge accumulating in the active column is discarded, such as by coupling the pixels of the active column to a ground element. The blanking step 505 may be performed at any time, such as between the sampling step 502 and the reset step 506 when a non-sampling interval is at the end of a pulse cycle, or between the transfer step 504 and a subsequent iteration of the collection step 503 when a non-sampling interval is between sampling intervals of within a pulse cycle. Alternatively, (such as when the number of storage columns is sufficiently large) some sampling intervals may only be used as gaps between sampling windows of interest.

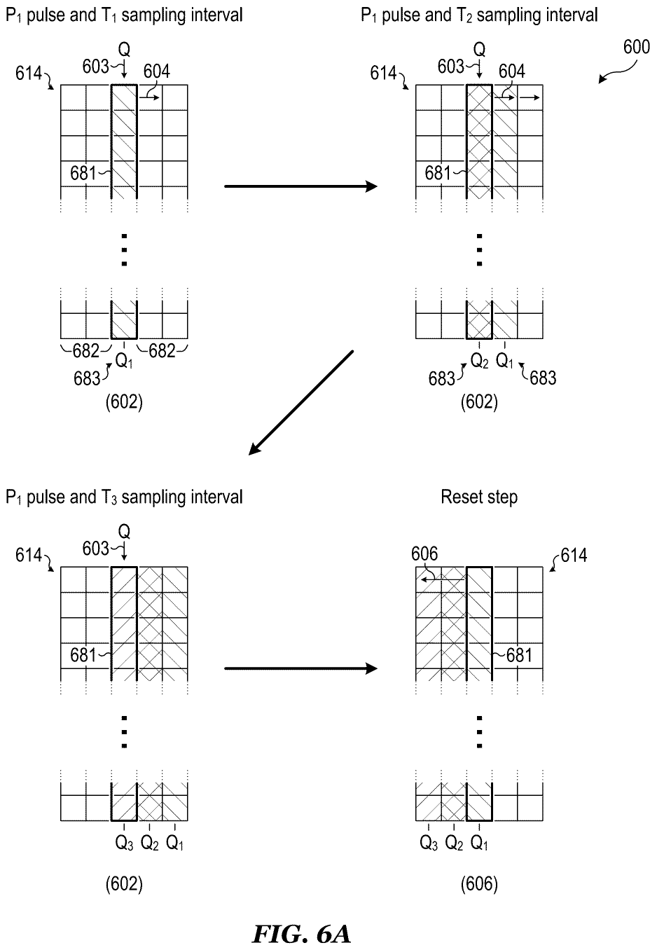

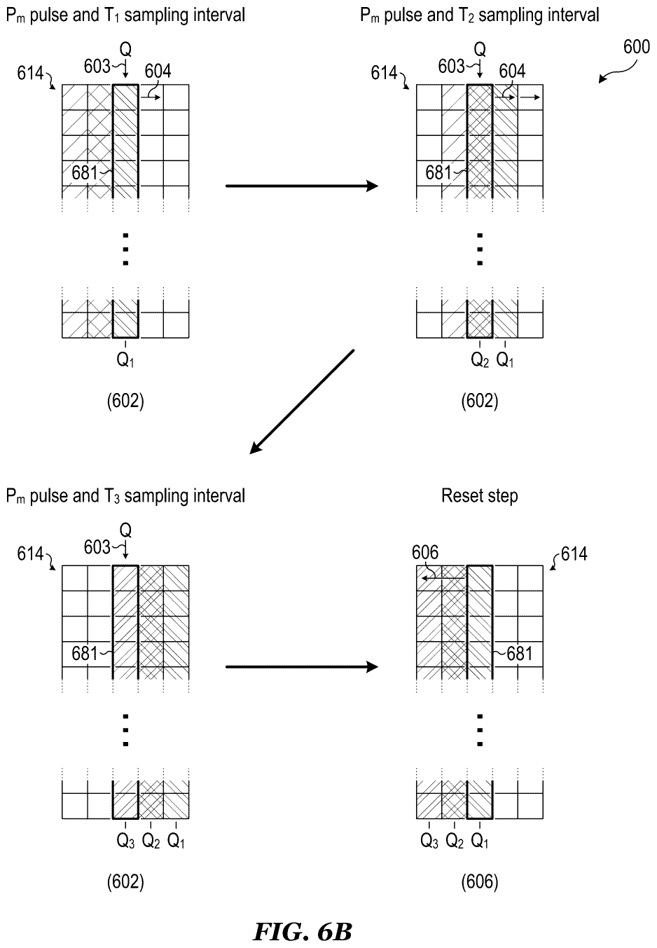

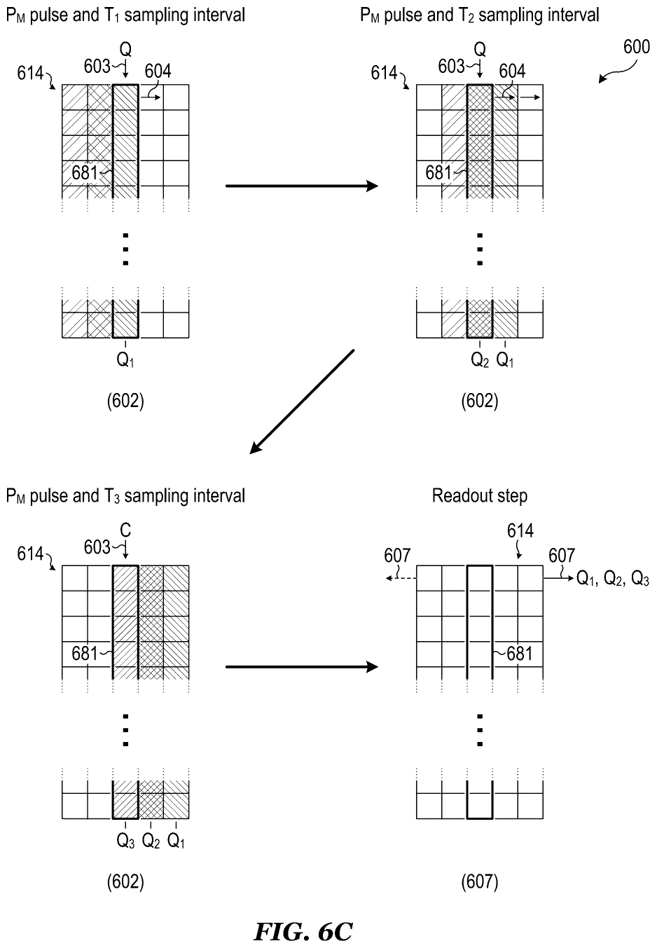

FIGS. 6A-6C schematically illustrate an example method of collecting optical data of a pulsed plasma where photoelectrons corresponding to N=3 sampling intervals are accumulated during each of M≥3 plasma pulses, where FIG. 6A shows a first sampling step and reset step, FIG. 6B shows an m^{th} sampling step and reset step, and FIG. 6C shows the last (M^{th}) sampling step in accordance with embodiments of the invention. The method of FIGS. 6A-6C may be combined with other methods and performed using the systems and apparatuses as described herein.

Referring to FIG. 6A, a method 600 shows the acquisition sequence for a multi-buffer sensor (N≥2). As previously discussed, some embodiment photosensitive charge transfer arrays may have a single active column and multiple storage columns. The column charges can be shifted forward from the active acquisition area (the active column) into a storage buffer (storage columns) and then shifted backwards to start the process over for the next pulse. As shown, a photosensitive charge transfer array 614 includes an active column 681 that collects light during desired sampling intervals of each pulse. After the end of a given sampling interval, collected photoelectrons are shifted forward into storage columns 682. Then, before the beginning of the first sampling interval of the next pulse, column charges 683 stored in the storage columns 682 are transferred back into the active column 681, and the process is repeated for multiple pulses.

In this specific example, the number of sampling intervals is three (N=3) and the last storage column is not directly connected to the active column 681. In this configuration, the photosensitive charge transfer array 614 has 2N−1=5 total columns with N−1=2 storage columns 682 on either side of the active column 681. Of course, this can be generalized to accommodate different numbers of sampling intervals, including much higher values of N, such as hundreds or thousands of storage columns.

Three iterations of a sampling step 602 including a collection step 603 and a transfer step 604 are performed for the first pulse P₁. During the first iteration of the sampling step 602, photoelectrons are accumulated into column charges Q₁ stored in the active column 681. The column charges Q₁ are then shifted forward one column during the transfer step 604. The process is repeated to acquire column charges Q₂ and column charges Q₃, resulting in the column charges Q₁ being stored in the last storage column. A reset step 606 is then performed during which stored charge in the sensor columns (each of Q₁, Q₂, and Q₃) are shifted backward until the column charges Q₁ are again in the active column 681 (which also results in the column charges Q₃ being in the first storage column.

Referring to FIG. 6B, the method 600 continues with three iterations of the sampling step 602 including the collection step 603 and the transfer step 604 being performed for any desired number of pulses M≥2. For example, the iterations of the sampling step 602 for the m^{th} pulse are shown. Notably, charge is accumulated for each sampling interval during each pulse. In particular, newly collected photoelectrons during each sampling interval are added to previously stored charge from previously accumulated photoelectrons. Again, the reset step 606 step is performed to shift the column charges Q₁ back into the active column 681.

Referring now to FIG. 6C, the method 600 concludes with three iterations of the sampling step 602 including the collection step 603 and the transfer step 604 for the last pulse P_{M}. The stored charge in the sensor columns is then read out during a readout step 607 (which may occur in either direction, as shown). For example, the photoelectrons from the sensor columns may be sequentially shifted out into a readout register. The photoelectrons in the readout register may then be optionally multiplied using electron multiplication (EM) circuit or other suitable method, then digitized using appropriate analog-to-digital-converter (ADC), and then are used for further processing.

As already discussed, the reset step 606 may or may not be performed or may be considered replaced by the readout step 607 for the last pulse P_{M} In one embodiment, the stored charge is shifted backward during the readout step 607 (e.g., since the forward and backward shift rates may be different and the backward shift rate may be selected to be faster since the all of the column charges are shifted backward during the reset step 606). Thus, by sequentially selecting different sampling intervals over multiple pulses it is advantageously possible to collect detailed information about the pulse and reconstruct the pulse shape.

It may be noted that during the reset step 606 (backward charge transfer across multiple sensor columns) unwanted light may be converted to photoelectrons and collected in active column 681 while column charges Qₙ are transferred through it. This effect can be minimized by the following methods.

(a) Selecting a backward charge transfer rate that is substantially higher than the forward (sampling) transfer rate. For example, a sampling interval may be on the order of 10 μs, the forward (sampling) transfer rate may be on the order of 100 kHz, and the backward charge transfer rate may be much higher, such as an order of magnitude more, or 60 times more, such as about 6 MHz in one embodiment.

(b) Suppressing photoelectrons generated in the active column from reaching corresponding electron wells during the backward charge transfer. In a non-limiting example, an electric field bias may be applied for that purpose.

(c) Blocking light (photons) from reaching the active column during the backward charge transfer. In non-limiting examples external or built-in optoelectronic, mechanical, or another type of light shutter may be applied for that purpose.

(d) Using a two-level sensor with closed loop of columns similar to tractor or tank track and single pick-up location for transferring charge to the readout register (examples of which will be discussed in more detail in the following). In the closed loop sensor configuration, the active sensor exposed to light may be on the first (top) level, and some storage columns would be on a second (bottom) level below the top level with charge moving column-to-column in closed loop.

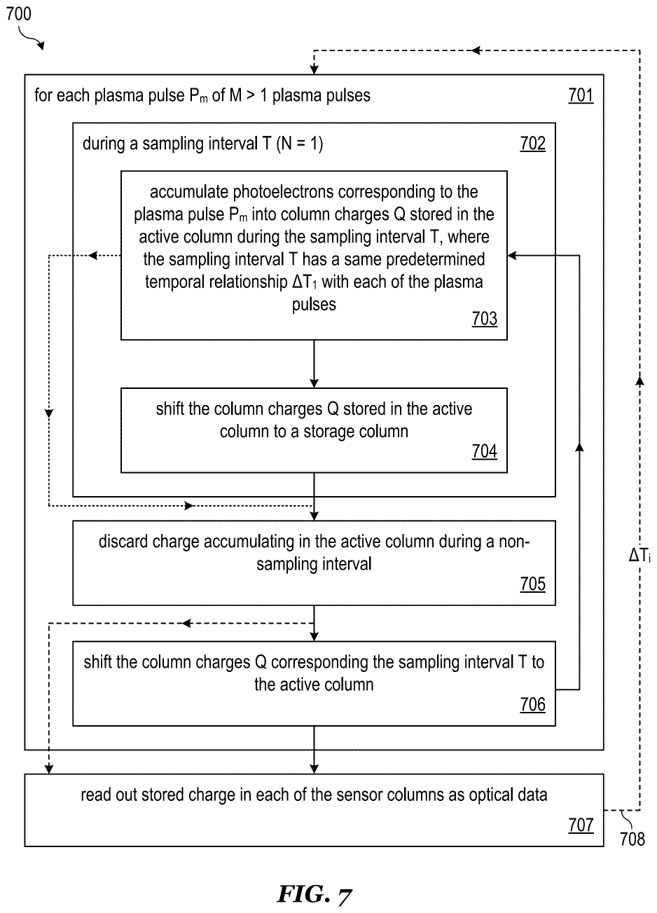

FIG. 7 illustrates a flowchart of an example method of collecting optical data of a pulsed plasma where photoelectrons corresponding to a single sampling interval (N=1) are accumulated during each of M>1 plasma pulses in accordance with embodiments of the invention. The method of FIG. 7 may be combined with other methods and performed using the systems and apparatuses as described herein. For example, the method of FIG. 7 may be combined with aspects of any of the embodiments of FIGS. 1A-6C and 8A-10C. Although shown in a logical order, the arrangement and numbering of the steps of FIG. 7 are not intended to be limited. The method steps of FIG. 7 may be performed in any suitable order or concurrently with one another, and additional steps, including intervening steps, may be performed as may be apparent to a person of skill in the art.

Referring to FIG. 7, a method 700 of collecting optical data of a pulsed plasma using a photosensitive charge transfer array of sensor columns comprising an active column and at least one storage column includes a measurement phase 701 that is performed for each plasma pulse Pₘ of M>1 plasma pulses. The measurement phase 701 includes a sampling step 702 and a reset step 706. The sampling step 702 includes a collection step 703 and a transfer step 704. In this specific example, the number of sampling intervals is one (N=1) and so the collection step 703 and the transfer step 704 are performed only once per plasma pulse Pₘ.

Once the column charges Q have been transferred out of the active column in the transfer step 704, accumulated charge is discarded (or prevented) during a blanking step 705 that lasts for a non-sampling interval between the sampling interval of the plasma pulse Pₘ and the sampling interval of the subsequent plasma pulse Pₘ₊₁. Before the next sampling step 702, the column charges Q are transferred back into the active column during the reset step 706. Alternatively, the newly accumulated charges from the subsequent plasma pulse can be added to the charges already in the storage column (i.e., without transferring charge back to the storage column).

The method 700 continues until the measurement phase 701 is performed for the last pulse P_{M}. The stored charge (column charges Q) is then read out as optical data in a readout step 707. As before, the entire method 700 may be repeated as desired be performing additional measurement phases 708 (and readout steps 707) for the desired sampling intervals.

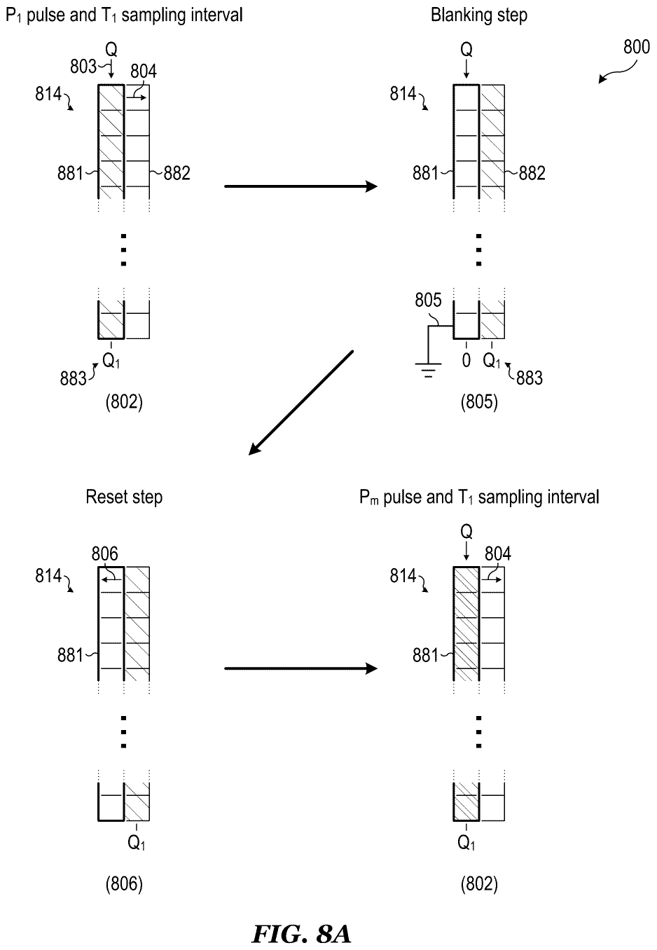

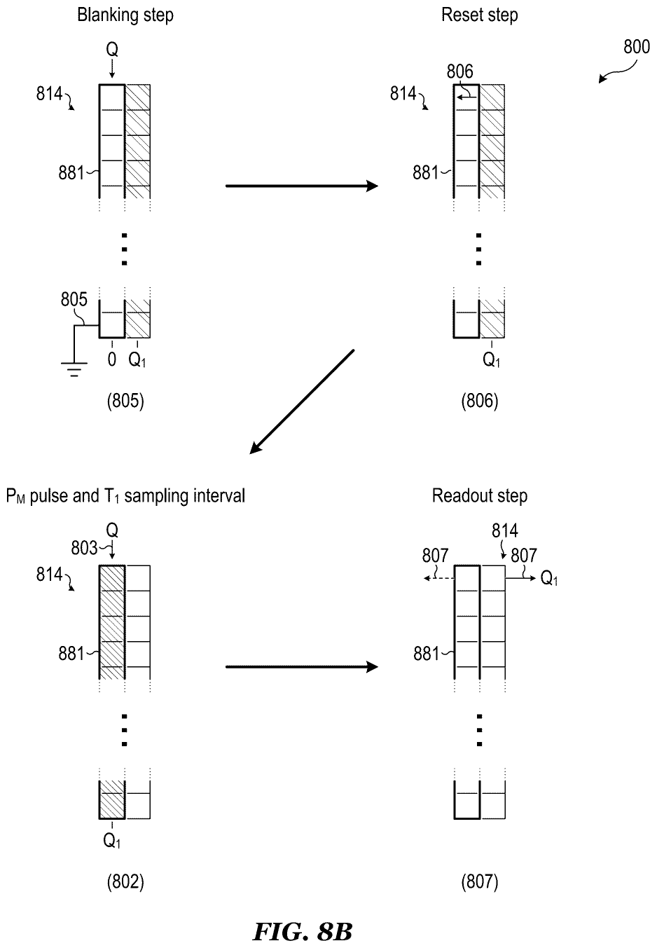

FIGS. 8A and 8B schematically illustrate a specific example of the method of FIG. 7 where FIG. 8A shows a first sampling step, blanking step, and reset step followed by an m^{th} sampling step, and where FIG. 8B shows an m^{th} blanking step and reset step followed by an M^{th} sampling step and a readout step in accordance with embodiments of the invention. The method of FIGS. 8A and 8B may be combined with other methods and performed using the systems and apparatuses as described herein.

Referring to FIG. 8A, a method 800 shows the acquisition sequence for single-buffer sensor (N=1). As previously discussed, some embodiment photosensitive charge transfer arrays may have only a single active column and a single storage column. The column charges can be transferred back and forth between the active acquisition area (the active column) into a storage buffer and back. As shown, a photosensitive charge transfer array 814 includes an active column 881 that only collects light during the desired sampling interval of each pulse. After the end of the desired sampling interval collected photoelectrons are transferred into a storage column 882, which is the only storage column of the photosensitive charge transfer array 814.

Then, before the beginning of the desired sampling interval of the next pulse, column charges 883 stored in the storage column 882 are transferred back into the active column 881, and the process is repeated for multiple pulses. Alternatively, at the beginning of the sampling interval for the next pulse, the column may be ungrounded. Charge may then accumulate in the active column and, at the end of the sampling interval, that charge may be added to the charge in the storage column (i.e., without transferring charge back to the storage column).

In this specific example, the number of sampling intervals is one (N=1). As shown, a sampling step 802 that includes a collection step 803 and a transfer step 804 is performed for a first pulse P₁. During a non-sampling interval, charge accumulating in the active column 881 is discarded during a blanking step 805 (while the column charges Q₁ are stored in the storage column 882). A reset step 806 is performed to transfer the column charges Q₁ into the active column 881, and the process is repeated for the desired number of pulses (M≥2 plasma pulses). As shown in FIG. 8B, the method 800 ends with the sampling step 802 including the collection step 803 and the transfer step 804 being performed for the last pulse P_{M} and a readout step 807 being performed.

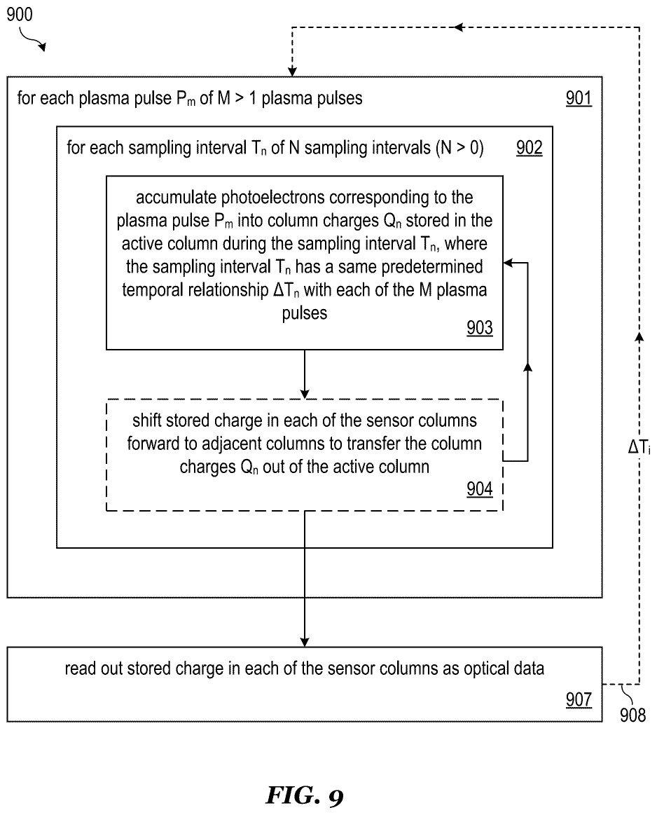

FIG. 9 illustrates a flowchart of an example method of collecting optical data of a pulsed plasma that omits the reset step in accordance with embodiments of the invention. The method of FIG. 9 may be combined with other methods and performed using the systems and apparatuses as described herein. For example, the method of FIG. 9 may be combined with aspects of any of the embodiments of FIGS. 1A-8B and 10A-10C. Although shown in a logical order, the arrangement and numbering of the steps of FIG. 9 are not intended to be limited. The method steps of FIG. 9 may be performed in any suitable order or concurrently with one another, and additional steps, including intervening steps, may be performed as may be apparent to a person of skill in the art.

Referring to FIG. 9, a method 900 of collecting optical data of a pulsed plasma using a photosensitive charge transfer array of sensor columns comprising an active column and at least one storage column includes a measurement phase 901 that is performed for each plasma pulse Pₘ of M>1 plasma pulses. Different from the method 600 of FIGS. 6A-6C, for example, the measurement phase 901 includes a sampling step 902 that includes a collection step 903 and a transfer step 904, but no reset step is needed. This is because in this specific example, the method 900 is performed using a photosensitive charge transfer array in a close loop configuration where a charge transfer pathway connects the last storage column to the active column. As a result, the transfer step 904 of the last sampling interval T_{N} of each iteration of the sampling step 902 shifts the column charges Q₁ corresponding to the first sampling interval T₁ into the active column without the need for the backward shifting of a reset step. As before, the method 900 continues until the measurement phase 901 is performed for the last pulse P_{M}. The stored charge is then read out as optical data in a readout step 907. As before, the entire method 900 may be repeated as desired be performing additional measurement phases 908 (and readout steps 907) for the desired sampling intervals.

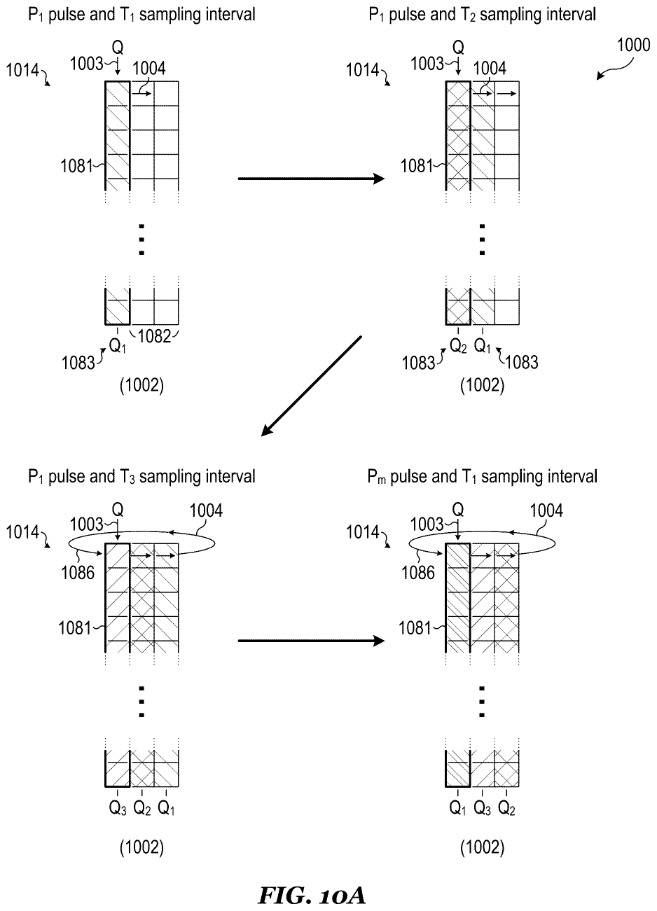

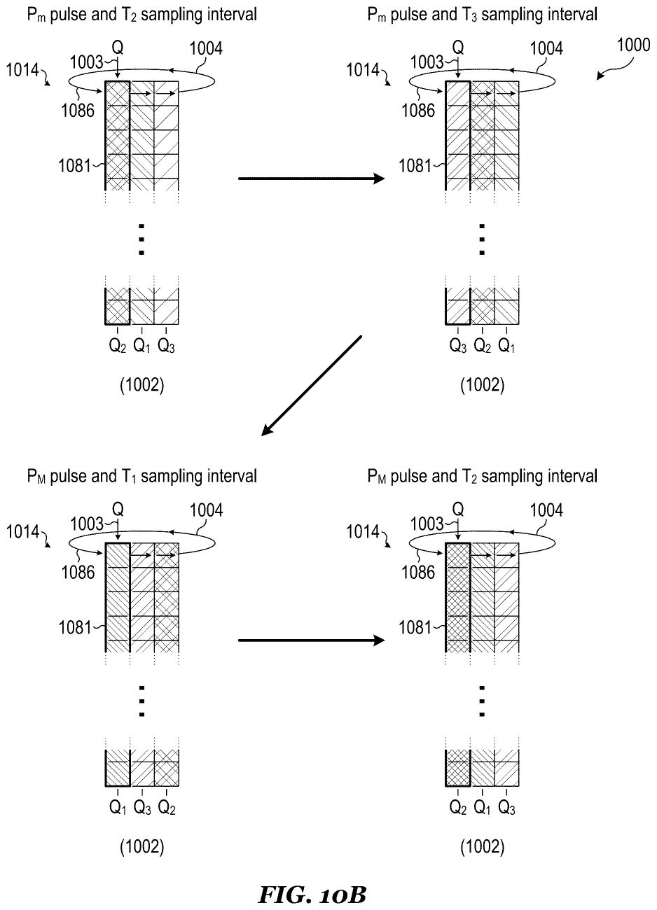

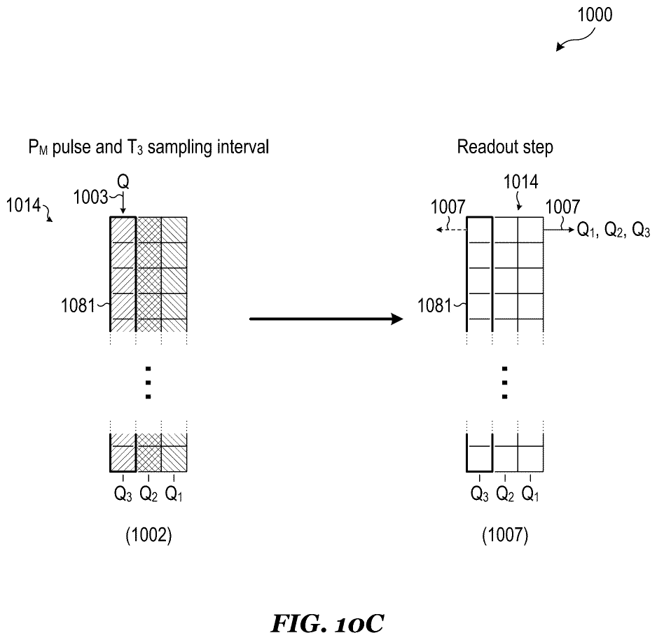

FIGS. 10A-10C schematically illustrate a specific example of the method of FIG. 9 wherein photoelectrons corresponding to N=3 sampling intervals are accumulated during M≥3 plasma pulses, where FIG. 10A shows collection and transfer steps for each sampling interval of a first plasma pulse followed by a collection and transfer step for the first sampling interval of an m^{th} plasma pulse, FIG. 10B shows collection and transfer steps for the remaining sampling intervals of the m^{th} plasma pulse followed by the first and second sampling intervals of an M^{th} plasma pulse, and FIG. 10C shows a collection step for the last sampling interval of the M^{th} plasma pulse followed by a readout step in accordance with embodiments of the invention. The method of FIGS. 10A-10C may be combined with other methods and performed using the systems and apparatuses as described herein.

Referring to FIG. 10A, a method 1000 shows the acquisition sequence for a multi-buffer sensor (N≥2) that uses a photosensitive charge transfer array 1014 that includes sensor columns including an active column 1081 and storage columns 1082, wherein the last storage column of the storage columns 1082 is connected to the active column 1081 via a charge transfer pathway to form a closed loop 1086 of sensor columns.

Three iterations of a sampling step 1002 including a collection step 1003 and a transfer step 1004 are performed for the first pulse P₁. During the first iteration of the sampling step 1002, photoelectrons are accumulated into column charges Q₁ stored in the active column 1081. The column charges Q₁ are then shifted forward one column during the transfer step 1004. The process is repeated to acquire column charges Q₂ and column charges Q₃, resulting in the column charges Q₁ being stored in the last storage column. In contrast to the method 600 of FIGS. 6A-6C, for example, no reset step is performed. Rather, the transfer step 1004 performs the reset automatically by transferring the column charges Q₁ from the last storage column to the active column 1081, as shown.

Now referring to the bottom right step of FIG. 10A and FIGS. 10B and 10C, the method 1000 continues with three iterations of the sampling step 1002 including the collection step 1003 and the transfer step 1004 being performed for any desired number of pulses M≥2 including the last pulse P_{M}, after which the stored charge in the sensor columns is read out during a readout step 1007 (which may occur in either direction, such as horizontally, as shown or even vertically).

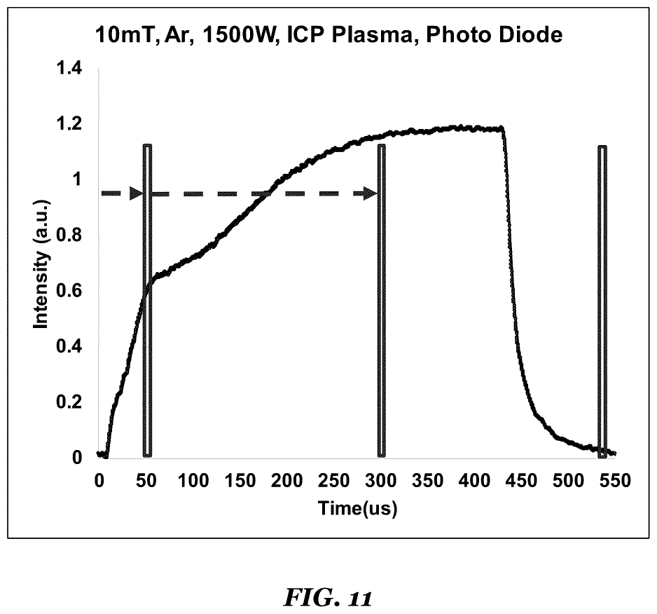

FIG. 11 illustrates example broadband optical data collected using a 10μs sampling interval. The data is collected and summed over a number of periodic optical events, such as plasma pulses. In this specific example, each of the sampling intervals is 10 μs in duration (a 10 μs wide measurement window). The sampling intervals may be different for different parts of the pulse, such as the beginning and end (tail) of the pulse, as shown. For example, a number of measurements may by made in steps over the pulse (e.g., the first half) when the signal strength is relatively strong and/or changing relatively quickly. One or more non-sampling intervals may also be included. One or more measurements may also be taken at the tail, (e.g., one 10 μs measurement, as shown, but of course other configurations are possible).

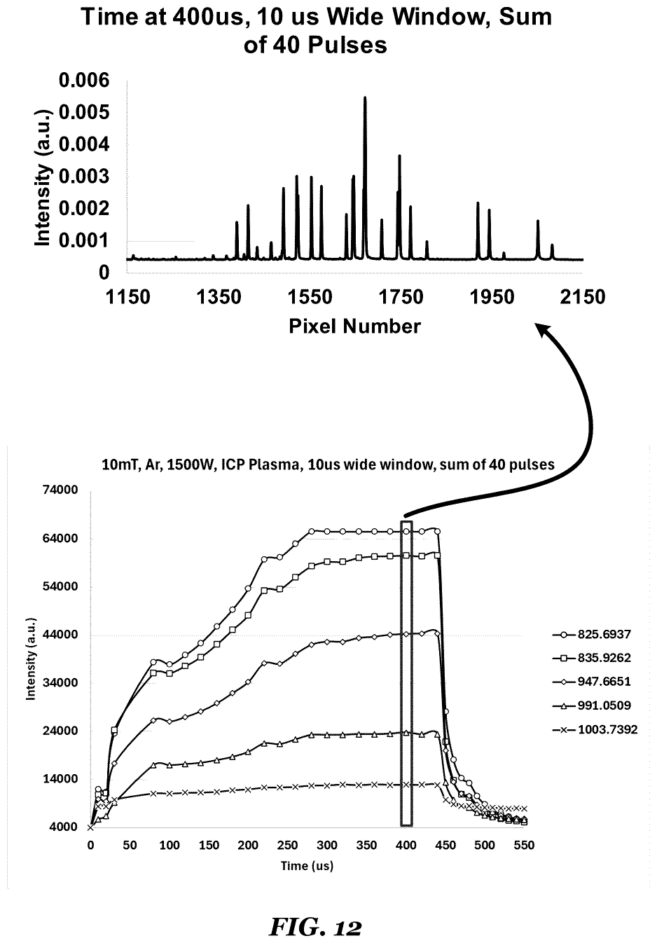

FIG. 12 illustrates example OES data collected using a 10 μs sampling interval. The data is collected and summed over a number of periodic optical events, such as plasma pulses. Each of the 10 μs sampling intervals is a “slice” of OES data containing intensity information associated with a pixel that can be converted into intensity at particular optical wavelengths. For example, the top graph shows intensity versus pixel number for a single sampling interval. By converting the pixel numbers to corresponding wavelengths, a time-resolved OES spectrum may be obtained. The bottom graph plots five example wavelengths versus time for such a time-resolved OES spectrum. The processing of the OES spectral data can be performed in any desired way, such as by converting the pixel numbers to wavelength in nanometers, formatting the spectral data around specific optical emission lines, taking ratios of lines, or simply tracking variation over time.

Example embodiments of the invention are summarized here. Other embodiments can also be understood from the entirety of the specification as well as the claims filed herein.

Example 1. An OES detection device including: an optical collector configured to receive an optical signal; a photosensitive charge transfer array including sensor columns configured to shift charge between columns, the sensor columns including an active column and at least one storage column, the active column being configured to accumulate photoelectrons during sampling intervals, and the at least one storage column being configured to store column charge corresponding respective sampling intervals; and an optically dispersive element configured to generate a dispersed optical signal from the optical signal, the dispersed optical signal being incident on and localized to the active column.

Example 2. The OES detection device of example 1, where the optically dispersive element is a diffraction element configured to narrow the optical bandwidth of the optical signal to generate the dispersed optical signal.

Example 3. The OES detection device of example 2, where the diffraction element is a diffraction grating.

Example 4. The OES detection device of one of examples 2 and 3, where the diffraction element is an adjustable diffraction element.

Example 5. The OES detection device of one of examples 1 to 4, where the photosensitive charge transfer array is a CCD.

Example 6. The OES detection device of example 5, where the CCD is in a TDI configuration.

Example 7. The OES detection device of one of examples 1 to 4, where the photosensitive charge transfer array includes a CMOS sensor.

Example 8. The OES detection device of one of examples 1 to 7, where the sensor columns include a plurality of storage columns.

Example 9. The OES detection device of example 8, where the OES detection device is configured to perform a sampling step and a reset step for each pulse Pₘ of M>1 pulses of a pulsed source, the sampling step including performing a collection step and a transfer step for each sampling interval Tₙ of N sampling intervals including a sampling interval T₁, the collection step including accumulating photoelectrons corresponding to the pulse Pₘ into column charges Qₙ stored in the active column during the sampling interval Tₙ, the transfer step including shifting stored charge in each of the sensor columns forward only a single column to respective adjacent columns to transfer the column charges Qₙ from the active column to a storage column, the reset step including shifting stored charge in each of the sensor columns backward N−1 columns to transfer column charges Q₁ corresponding the sampling interval T₁ to the active column, where the sensor columns consist of the active column and 2N−2 storage columns.

Example 10. The OES detection device of example 8, where the OES detection device is configured to perform a sampling step for each pulse Pₘ of M>1 pulses of a pulsed source, the sampling step including performing a collection step and a transfer step for each sampling interval Tₙ of N sampling intervals including a sampling interval T₁, the collection step including accumulating photoelectrons corresponding to the pulse Pₘ into column charges Qₙ stored in the active column during the sampling interval Tₙ, the transfer step including shifting stored charge in each of the sensor columns forward to respective adjacent columns to transfer the column charges Qₙ from the active column to a first storage column, where the sensor columns consist of the active column and N−1 storage columns arranged in a closed loop, the first storage column and a last storage column both being directly coupled to the active column.

Example 11. The OES detection device of one of examples 1 to 7, further including: a grounding element coupled to the active column and configured to discard charge accumulated in the active column during non-sampling intervals.

Example 12. The OES detection device of example 11, where the at least one storage column consists of a single storage column.

13. A method of collecting optical data of a pulsed plasma using a photosensitive charge transfer array of sensor columns including an active column and at least one storage column, the method including: performing a sampling step for each plasma pulse Pₘ of M>1 plasma pulses, the sampling step including performing a collection step and a transfer step for each sampling interval Tₙ of N sampling intervals including a sampling interval T₁, the collection step including accumulating photoelectrons corresponding to the plasma pulse Pₘ into column charges Qₙ stored in the active column during the sampling interval Tₙ, where the sampling interval Tₙ has a same predetermined temporal relationship ΔTₙ with each of the plasma pulses, the transfer step including shifting stored charge in some or all of the sensor columns to respective adjacent columns to transfer the column charges Qₙ out of the active column; and reading out stored charge in each of the sensor columns as the optical data after accumulating photoelectrons corresponding to the last plasma pulse P_{M} during the last sampling interval T_{N}.

Example 14. The method of example 13, where the sampling step further includes: a blanking step including discarding charge accumulating in the active column during at least one non-sampling interval.

Example 15. The method of example 14, where N=1, the array of sensor columns consisting of a single storage column, and where the transfer step includes adding the stored charge in the active column to the stored charge in the single storage column.

Example 16. A method of collecting optical data of a pulsed plasma using a photosensitive charge transfer array of sensor columns including an active column and at least one storage column, the method including: performing a sampling step and a reset step for each plasma pulse Pₘ of M>1 plasma pulses, the sampling step including performing a collection step and a transfer step for each sampling interval Tₙ of N sampling intervals including a sampling interval T₁, the collection step including accumulating photoelectrons corresponding to the plasma pulse Pₘ into column charges Qₙ stored in the active column during the sampling interval Tₙ, where the sampling interval Tₙ has a same predetermined temporal relationship ΔTₙ with each of the plasma pulses, the transfer step including shifting stored charge in each of the sensor columns to respective adjacent columns to transfer the column charges Qₙ out of the active column, the reset step including, for m<M, shifting stored charge in each of the sensor columns to respective adjacent columns to transfer column charges Q₁ corresponding to the sampling interval T₁ to the active column; and reading out stored charge in each of the sensor columns as the optical data after accumulating photoelectrons corresponding to the last plasma pulse P_{M} during the last sampling interval T_{N}.

Example 17. The method of example 16, where the N sampling intervals include N>1 sampling intervals so that N>1 iterations of the collection step are performed for each iteration of the sampling step.

Example 18. The method of example 17, where the sensor columns consist of the active column and 2N−2 storage columns, where the transfer step includes shifting stored charge in each of the sensor columns forward only a single column, and where the reset step includes shifting stored charge in each of the sensor columns backward N−1 columns to transfer the column charges Q₁ to the active column.

Example 19. The method of example 17, where the sensor columns consist of the active column and N−1 storage columns arranged in a closed loop, a first storage column and a last storage column of the N−1 storage columns both being directly coupled to the active column, where the transfer step includes shifting stored charge in each of the sensor columns forward, and where the reset step includes a last iteration of the transfer step during which the column charges Q₁ is shifted forward from the last storage column to transfer the column charges Q₁ to the active column.

Example 20. The method of one of examples 16 to 19, where the sampling step further includes: a blanking step including discarding charge accumulating in the active column during at least one non-sampling interval.

Example 21. The method of example 20, where N=1, the N sampling intervals consisting of the sampling interval T₁ separated from a subsequent sampling interval T₁ of a subsequent plasma pulse Pₘ₊₁ by a single non-sampling interval so that a single iteration of the collection step, the transfer step, and the blanking step are performed for each iteration of the sampling step.

Example 22. The method of one of examples 16 to 21, where each of the sensor columns includes X>1 pixels, each configured to store optical spectroscopic information from accumulated photoelectrons with sensor rows indicating wavelength and pixel charge indicating intensity, and where the collection step includes accumulating the photoelectrons from a dispersed optical signal incident on the active column during the sampling interval Tₙ.

Example 23. The method of claim 22 further including: dispersing optical signals of the pulsed plasma using a diffraction grating to generate the dispersed optical signal, the photosensitive charge transfer array being a CCD in a TDI configuration that is configured together with the diffraction grating as a spectrometer.

Example 24. An OES system including: a pulsed plasma apparatus including a processing chamber and configured to generate a plasma having M>1 plasma pulses in the processing chamber; an OES detection device optically coupled to the plasma and including an optical collector configured to receive an optical signal; a photosensitive charge transfer array of sensor columns including an active column and at least one storage column; and an optically dispersive element configured to generate a dispersed optical signal from the optical signal, the dispersed optical signal being incident on and localized to the active column; and a control and data acquisition circuit electrically coupled to the photosensitive charge transfer array and configured to perform a sampling step and a reset step for each plasma pulse Pₘ of the M>1 plasma pulses, the sampling step including performing a collection step and a transfer step for each sampling interval Tₙ of N sampling intervals including a sampling interval T₁, the collection step including accumulating photoelectrons corresponding to the plasma pulse Pₘ into column charges Qₙ in the active column during the sampling interval Tₙ, where the sampling interval Tₙ has a same predetermined temporal relationship ΔTₙ with each of the plasma pulses, the transfer step including shifting stored charge in each of the sensor columns to respective adjacent columns to transfer the column charges Qₙ out of the active column, the reset step including, for m<M, shifting stored charge in each of the sensor columns to respective adjacent columns to transfer column charges Q₁ corresponding to the sampling interval T₁ to the active column, and read out stored charge in each of the sensor columns as optical data after accumulating photoelectrons corresponding to the last plasma pulse P_{M} during the last sampling interval T_{N}.

Example 25. The OES system of example 24, further including: an SP control path configured to generate the plasma in the processing chamber using a sequence of SP pulses; and a timing circuit electrically coupled to the control and data acquisition circuit, the timing circuit being configured to receive a synchronization signal corresponding to the sequence of SP pulses, use the synchronization signal to trigger the control and data acquisition circuit to perform iterations of the transfer step and the reset step according to respective predetermined temporal relationships ΔTₙ with the SP pulses.

Example 26. The OES system of example 25, where the timing circuit is configured to use the synchronization signal to trigger the control and data acquisition circuit by generating a sampling frequency greater than a pulse frequency of the sequence of SP pulses, generating a trigger signal having the sampling frequency after a setup delay triggered by the synchronization signal, and outputting the trigger signal to the control and data acquisition circuit.

Example 27. The OES system of one of examples 24 to 26, where the N sampling intervals include N>1 sampling intervals so that N>1 iterations of the collection step are performed for each iteration of the sampling step, where the sensor columns consist of the active column and 2N−2 storage columns, where the transfer step includes shifting stored charge in each of the sensor columns forward only a single column, and where the reset step includes shifting stored charge in each of the sensor columns backward N−1 columns to transfer the column charges Q₁ to the active column.

Example 28. The OES system of one of examples 24 to 27, further including: a grounding element coupled to the active column and configured to discard charge accumulated in the active column during non-sampling intervals.

Example 29. The OES system of one of examples 24 to 28, where the optically dispersive element is a diffraction grating, and where the photosensitive charge transfer array is a CCD including the sensor columns in a TDI configuration that is configured together with the diffraction grating as a spectrometer.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An optical emission spectroscopy (OES) detection device comprising:
an optical collector configured to receive an optical signal;
a photosensitive charge transfer array comprising sensor columns configured to shift charge between columns, the sensor columns comprising an active column and at least one storage column, the active column being configured to accumulate photoelectrons during sampling intervals, and the at least one storage column being configured to store column charge corresponding to respective sampling intervals; and
an optically dispersive element configured to generate a dispersed optical signal from the optical signal, the dispersed optical signal being incident on and localized to the active column.

2. The OES detection device of claim 1, wherein the sensor columns comprise a plurality of storage columns.

3. The OES detection device of claim 2, wherein the OES detection device is configured to
perform a sampling step and a reset step for each pulse Pₘ of M>1 pulses of a pulsed source,
the sampling step comprising performing a collection step and a transfer step for each sampling interval Tₙ of N sampling intervals comprising a sampling interval T₁,
the collection step comprising accumulating photoelectrons corresponding to the pulse Pₘ into column charges Qₙ stored in the active column during the sampling interval Tₙ,
the transfer step comprising shifting stored charge in each of the sensor columns forward only a single column to respective adjacent columns to transfer the column charges Qₙ from the active column to a storage column,
the reset step comprising shifting stored charge in each of the sensor columns backward N−1 columns to transfer column charges Q₁ corresponding the sampling interval T₁ to the active column,
wherein the sensor columns consist of the active column and 2N−2 storage columns.

4. The OES detection device of claim 2, wherein the OES detection device is configured to
perform a sampling step for each pulse Pₘ of M>1 pulses of a pulsed source,
the sampling step comprising performing a collection step and a transfer step for each sampling interval Tₙ of N sampling intervals comprising a sampling interval T₁,
the collection step comprising accumulating photoelectrons corresponding to the pulse Pₘ into column charges Qₙ stored in the active column during the sampling interval Tₙ,
the transfer step comprising shifting stored charge in each of the sensor columns forward to respective adjacent columns to transfer the column charges Qₙ from the active column to a first storage column,
wherein the sensor columns consist of the active column and N−1 storage columns arranged in a closed loop, the first storage column and a last storage column both being directly coupled to the active column.

5. The OES detection device of claim 1, further comprising:
a grounding element coupled to the active column and configured to discard charge accumulated in the active column during non-sampling intervals.

6. The OES detection device of claim 5, wherein the at least one storage column consists of a single storage column.

7. A method of collecting optical data of a pulsed plasma using a photosensitive charge transfer array of sensor columns comprising an active column and at least one storage column, the method comprising:
performing a sampling step and a reset step for each plasma pulse Pₘ of M>1 plasma pulses,
the sampling step comprising performing a collection step and a transfer step for each sampling interval Tₙ of N sampling intervals comprising a sampling interval T₁,
the collection step comprising accumulating photoelectrons corresponding to the plasma pulse Pₘ into column charges Qₙ stored in the active column during the sampling interval Tₙ, wherein the sampling interval Tₙ has a same predetermined temporal relationship ΔTₙ with each of the plasma pulses,
the transfer step comprising shifting stored charge in each of the sensor columns to respective adjacent columns to transfer the column charges Qₙ out of the active column,
the reset step comprising, for m<M, shifting stored charge in each of the sensor columns to respective adjacent columns to transfer column charges Q₁ corresponding to the sampling interval T₁ to the active column; and
reading out stored charge in each of the sensor columns as the optical data after accumulating photoelectrons corresponding to the last plasma pulse P_{M} during the last sampling interval T_{N}.

8. The method of claim 7, wherein the N sampling intervals comprise N>1 sampling intervals so that N>1 iterations of the collection step are performed for each iteration of the sampling step.

9. The method of claim 8,
wherein the sensor columns consist of the active column and 2N−2 storage columns,
wherein the transfer step comprises shifting stored charge in each of the sensor columns forward only a single column, and
wherein the reset step comprises shifting stored charge in each of the sensor columns backward N−1 columns to transfer the column charges Q₁ to the active column.

10. The method of claim 8,
wherein the sensor columns consist of the active column and N−1 storage columns arranged in a closed loop, a first storage column and a last storage column of the N−1 storage columns both being directly coupled to the active column,
wherein the transfer step comprises shifting stored charge in each of the sensor columns forward, and
wherein the reset step comprises a last iteration of the transfer step during which the column charges Q₁ is shifted forward from the last storage column to transfer the column charges Q₁ to the active column.

11. The method of claim 7, wherein the sampling step further comprises:
a blanking step comprising discarding charge accumulating in the active column during at least one non-sampling interval.

12. The method of claim 11, wherein N=1, the N sampling intervals consisting of the sampling interval T₁ separated from a subsequent sampling interval T₁ of a subsequent plasma pulse Pₘ₊₁ by a single non-sampling interval so that a single iteration of the collection step, the transfer step, and the blanking step are performed for each iteration of the sampling step.

13. The method of claim 7,
wherein each of the sensor columns comprises X>1 pixels, each configured to store optical spectroscopic information from accumulated photoelectrons with sensor rows indicating wavelength and pixel charge indicating intensity, and
wherein the collection step comprises accumulating the photoelectrons from a dispersed optical signal incident on the active column during the sampling interval Tₙ.

14. The method of claim 13 further comprising:
dispersing optical signals of the pulsed plasma using a diffraction grating to generate the dispersed optical signal, the photosensitive charge transfer array being a charge coupled device (CCD) in a time delay integration (TDI) configuration that is configured together with the diffraction grating as a spectrometer.

15. An optical emission spectroscopy (OES) system comprising:
a pulsed plasma apparatus comprising a processing chamber and configured to generate a plasma having M>1 plasma pulses in the processing chamber;
an OES detection device optically coupled to the plasma and comprising
an optical collector configured to receive an optical signal;
a photosensitive charge transfer array of sensor columns comprising an active column and at least one storage column; and
an optically dispersive element configured to generate a dispersed optical signal from the optical signal, the dispersed optical signal being incident on and localized to the active column; and
a control and data acquisition circuit electrically coupled to the photosensitive charge transfer array and configured to
perform a sampling step and a reset step for each plasma pulse Pₘ of the M>1 plasma pulses,
the sampling step comprising performing a collection step and a transfer step for each sampling interval Tₙ of N sampling intervals comprising a sampling interval T₁,
the collection step comprising accumulating photoelectrons corresponding to the plasma pulse Pₘ into column charges Qₙ in the active column during the sampling interval Tₙ, wherein the sampling interval Tₙ has a same predetermined temporal relationship ΔTₙ with each of the plasma pulses,
the transfer step comprising shifting stored charge in each of the sensor columns to respective adjacent columns to transfer the column charges Qₙ out of the active column,
the reset step comprising, for m<M, shifting stored charge in each of the sensor columns to respective adjacent columns to transfer column charges Q₁ corresponding to the sampling interval T₁ to the active column, and
read out stored charge in each of the sensor columns as optical data after accumulating photoelectrons corresponding to the last plasma pulse P_{M} during the last sampling interval T_{N}.

16. The OES system of claim 15, further comprising:
a source power (SP) control path configured to generate the plasma in the processing chamber using a sequence of SP pulses; and
a timing circuit electrically coupled to the control and data acquisition circuit, the timing circuit being configured to
receive a synchronization signal corresponding to the sequence of SP pulses,
use the synchronization signal to trigger the control and data acquisition circuit to perform iterations of the transfer step and the reset step according to respective predetermined temporal relationships ΔTₙ with the SP pulses.

17. The OES system of claim 16, wherein the timing circuit is configured to use the synchronization signal to trigger the control and data acquisition circuit by
generating a sampling frequency greater than a pulse frequency of the sequence of SP pulses,
generating a trigger signal having the sampling frequency after a setup delay triggered by the synchronization signal, and
outputting the trigger signal to the control and data acquisition circuit.

18. The OES system of claim 15,
wherein the N sampling intervals comprise N>1 sampling intervals so that N>1 iterations of the collection step are performed for each iteration of the sampling step,
wherein the sensor columns consist of the active column and 2N−2 storage columns,
wherein the transfer step comprises shifting stored charge in each of the sensor columns forward only a single column, and
wherein the reset step comprises shifting stored charge in each of the sensor columns backward N−1 columns to transfer the column charges Q₁ to the active column.

19. The OES system of claim 15, further comprising:
a grounding element coupled to the active column and configured to discard charge accumulated in the active column during non-sampling intervals.

20. The OES system of claim 15,
wherein the optically dispersive element is a diffraction grating, and
wherein the photosensitive charge transfer array is a charge coupled device (CCD) comprising the sensor columns in a time delay integration (TDI) configuration that is configured together with the diffraction grating as a spectrometer.
